(19) United States
(12) Patent Application Publication
(10) Pub. No.: US 2008/0268934 A1
(43) Pub. Date: Oct. 30, 2008

(54) Technique for displaying gaming machine information using machine readable display mechanisms

(75) Inventors: Harold E. Mattice, Gardnerville, NV (US); Ricky J. Lew, Reno, NV (US); Jamal Benbrahim, Reno, NV (US)

Correspondence Address: Weaver Austin Villeneuve & Sampson LLP - IGT;Attn: IGT, P.O. Box 70250, Oakland, CA, 94612-0250, US

(73) Assignee: IGT

(21) Appl. No.: 11/796,589

(22) Filed: Apr. 26, 2007

(51) Int. Cl. A63F 9/24; A63F 13/00; A63F 13/02

(52) U.S. Cl. 463/16; 463/42; 463/47

(57) ABSTRACT

Various aspects are directed to gaming machines, and more particularly to techniques for dynamically generating and displaying gaming machine related information in at least one format which can be read (and/or otherwise interpreted) by appropriately configured electronic devices.

### BACKGROUND

This invention relates generally to casino gaming machines and casino accounting and auditing operations.

In many gaming jurisdictions, various regulations have been established to ensure that casinos properly track and report various types of gaming-related information. One such type of information relates to gaming machine coin information which, for example, may be used for auditing and tax purposes.

Typically, in traditional gaming machines, mechanical meters and counters are used to tally the amount of coins accepted by the machine, amount of coins paid out, and the amount of coins held by a gaming machine. Typically each gaming machine includes it own respective set of meters and counters which are installed within the gaming machine cabinet and which are visible through a window in the housing of the gaming machine cabinet. Accordingly, in order to read the gaming machine meter/counter data, it is often necessary for casino employees to go the physical location of the gaming machine, and peer into the cabinet window in order to view the digits displayed on the mechanical meters and counters.

Typically, the digits of the mechanical meters and counters are displayed via the use of rotating mechanical reels, each of which displays a permanent set of digits which, typically, are about a tenth of an inch high. The mechanical meters may be located within the gaming machine at a location that may be difficult to view or access by an employee desiring to read the meter data. As a result, traditional activities involving the collection of gaming machine coin information are often labor and time intensive.

### SUMMARY

Various aspects of one or more embodiments are directed to a casino gaming machine which includes a master gaming controller, a first meter, memory, and at least one interface. In at least one embodiment, the first meter is operable to track gaming machine information, and includes a first meter display. According to specific embodiments, the gaming machine may be operable to control play of a wager-based game, and display a first portion of the gaming machine information at the first meter display. In at least one embodiment, the first portion of gaming machine information includes a first portion of non-alphanumeric content formatted according to a first machine readable display format.

Other aspects of one or more embodiments are directed to a meter device operable for use with an electronic gaming machine which is operable to control play of a wager-based game. In at least one embodiment, the meter device may include at least one interface, an information tracking mechanism operable to track gaming machine information relating to the gaming machine, and a first meter display operable to display meter data relating to the tracked gaming machine information. In one embodiment, the meter device may be operable to display a first portion of the meter data at the first meter display, wherein the first portion of meter data includes a first portion of non-alphanumeric content formatted according to a first machine readable display format.

Other aspects of one or more embodiments are directed to a casino gaming machine which includes a master gaming controller, a first electronic display, memory, and at least one interface. In at least one embodiment, the gaming machine may be operable to control play of a wager-based game; identify a first portion of data to be presented for display at the first display using a machine readable format; convert the first portion of data into non-alphanumeric content formatted according to a first machine readable display format; and display the non-alphanumeric content at the first display.

Other aspects of one or more embodiments are directed to a gaming system comprising a first gaming machine including a first display, a first server system, and a first electronic reading device. In at least one embodiment, the first gaming machine may be operable to control play of a wager-based game, identify a first portion of data to be presented for display at the first display using a machine readable format, and to present the first portion of data for display at the first display using non-alphanumeric content formatted according to a first machine readable display format. In at least one embodiment, the first electronic reading device may be operable to read the non-alphanumeric content displayed at the first display, determine the first portion of data using at least a portion of the read non-alphanumeric content, and/or forward at least a portion of the first portion of content to the first server system.

Additional objects, features and advantages of the various aspects of a specific embodiment will become apparent from the following description of its preferred embodiments, which description should be taken in conjunction with the accompanying drawings.

### BRIEF DESCRIPTION OF THE DRAWINGS

FIG. 1 shows a perspective view of an exemplary gaming machine 2 in accordance with a specific example of an embodiment.

FIG. 2 is a simplified block diagram of an exemplary gaming machine 200 in accordance with a specific embodiment.

FIG. 3 is a simplified block diagram of an exemplary mobile device 300 in accordance with a specific example of an embodiment.

FIG. 4 shows a specific example of an embodiment of a gaming network 400 which may be used for implementing various features.

FIG. 5 shows an example of a portion 500 of a hard meter in accordance with a specific embodiment.

FIG. 6 shows an alternate example embodiment of a portion 600 of a display surface which may be implementing various aspects described herein.

FIG. 7 shows an alternate example embodiment of a meter display portion 700.

FIG. 8 shows a flow diagram of a Meter Reading Procedure 800 accordance with the specific embodiment of the present invention.

FIG. 9 shows an example of an interaction diagram in accordance with any specific embodiment.

FIG. 10 shows a diagram of a Machine Download Procedure 1000 in accordance with the specific embodiment.

FIG. 11 shows a flow diagram of a Barcode Data Generation Procedure 1100 in accordance with a specific embodiment.

FIGS. 12-13 show various embodiments of types of machine readable display content which may be displayed at an electronic display device.

### DETAILED DESCRIPTION OF EXAMPLE EMBODIMENTS

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Various aspects relating to embodiments described herein are directed to gaming machines, and more particularly to techniques for generating and displaying gaming machine related information in at least one format which can be read (and/or otherwise interpreted) by appropriately configured electronic devices.

For example, according to specific embodiments, gaming machine meter data (such as that generated, for example, by one or more hard and/or soft meters at a gaming machine) may be encoded into different types of machine readable display data (herein referred to generally as “barcode data”) which, when displayed, may be read by an electronic device such as, for example, a barcode scanner device and/or other types of electronic devices capable of reading the machine readable display data. According to some embodiments, such electronic devices may be configured or designed to optically scan and read encoded information (which, for example may be displayed using alpha-numeric and/or graphical symbols) which is displayed at the gaming machine (e.g., via an electronic display device, or via a mechanical display mechanism).

According to specific embodiments, different gaming machines may include hard meters, soft meters and/or some combination thereof. As described herein, the terms “meter” and “counter” may be used interchangeably.

In at least some embodiments where a gaming machine includes one or more hard meters, the hard meters may be implemented using mechanical meters which, for example, are located inside the gaming machine cabinet. According to specific embodiments, the meters may be operable to track various types of gaming machine related information such as, for example, Coin In information, Coin Out information, Jackpot information, Games Played, Game Won, Game Lost, etc.

The hard meters may be located on the inside of the door, on the back wall, or on a meter board that can be read from outside the machine. Some casino installations require that the gaming machine meters (e.g., hard meters) be viewable from outside the gaming machine, for example, in order to enable the meters to be read without opening the door of the gaming machine cabinet. Additionally, some jurisdictions require that the hard meter wiring be hard wired to the processor board in order, for example, to prevent the hard meters from being disconnected.

In at least some embodiments, gaming machines may include soft meters. In at least one embodiment, soft meters may be implemented as virtual meters located in software. In at least some embodiments, the soft meter information may be stored in non volatile memory. In at least one embodiment, at least a portion of the soft meter information may be reported to one or more remote systems.

In at least some embodiments where a gaming machine includes both hard meters and soft meters, it may be desirable that the soft meter data be synchronized with the hard meter data. However, one issue which may prevent such synchronization relates to the fact that at least some soft meters can be cleared. For example, when new firmware is installed in the gaming machine, the soft meters may be cleared or reset back to all zeros, which may result in the hard meters and the soft meters being out of sync with each other. In such situations, special records may be kept which, for example, may include information relating to times/dates when the soft meters of the gaming machine were cleared.

According to specific embodiments, the hard meters and/or soft meters of a gaming machine may be read at various times throughout the life of the gaming machine. Records may be kept on the meter readings in order to provide data for subsequent analysis such as, for example, the amount of money accepted by the machine, the amount of money paid out by the machine, the amount of money accumulated in the drop of the machine, which game(s) received the most play, etc.

According to specific embodiments, and may be desirable to periodically compare the hard meter data with the soft meter data associated with a given gaming machine. In at least some embodiments, differences between the hard meter reading and soft meter reading may indicate a problem or issue with the gaming machine. For example, a difference between the hard/soft “Coin Out” meters may indicate that the machine has been cheated. At this point the video tapes may be reviewed and/or other actions may be taken.

Conventionally, when an operator is required read the meters on a gaming machine, the operator would typically take a sheet of paper to the gaming machine, record the gaming machine serial number, visually observe the numbers indicated by the meters, and manually write down all of the meter readings for that machine. Problems arise, however, when the operator transposes some of the digits on one or more of the meter readings. Additionally, because the manually recorded meter readings are typically required to be manually entered into a computer database, additional errors may arise during the data entry. Such errors can cause accounting/taxation issues, and may require the operator to re-read the meters for that gaming machine. Additionally, such errors may also lead to erroneous analysis of the hard/soft meter data.

Accordingly, various aspects disclosed herein relate to different techniques for automating at least a portion of activities involved in the collection and/or management of gaming machine meter data.

For example, in one embodiment, gaming machine meter data (such as that generated, for example, by one or more hard and/or soft meters at a gaming machine) may be encoded into different types of machine readable display data (herein referred to generally as “barcode data”) which, when displayed, may be read by an electronic device such as, for example, a barcode scanner device and/or other types of electronic devices capable of reading the machine readable display data. In at least some embodiments, an electronic display reading device (such as, for example, a mobile electronic device which is configured or designed to read the machine readable display data) may be used to optically scan, read, and record the machine readable data displayed at the gaming machine. According to some embodiments, such electronic devices may be configured or designed to read encoded information (which, for example may be displayed using alpha-numeric and/or graphical symbols) which is displayed at the gaming machine (e.g., via an electronic display device, or via a mechanical display mechanism). Further, in at least some embodiments, the machine readable data which was read and recorded by the electronic display reading device may be provided to one or more remote systems for storage and/or analysis. In this way, various activities involved in the collection and/or management of gaming machine meter data may be automated in a manner which may significantly reduce the involvement of manually implemented operations and the associated errors which may be introduced therefrom.

In at least one embodiment, various types of gaming machine information may be encoded into barcode data, which may be displayed (e.g., via an electronic display device, and/or via a mechanical display mechanism) at the gaming machine using alpha-numeric and/or graphical symbols. Examples of various types of gaming machine information which may be encoded may include, but are not limited to, one or more of the following (or combination thereof): firmware model numbers; firmware versions; part numbers (e.g., relating to components of the gaming machine); revision numbers; configuration information; serial numbers; check sums; hard meter data; soft meter data; game download information; local network information; etc. In one embodiment, the displayed barcode data may be scanned and recorded via the use of a mobile scanning device such as, for example, the 1802 Vista Cordless barcode reader manufactured by Intermec, Inc. (see, e.g., www.Intermec.com). It will be appreciated that such embodiments may reduce or eliminate errors attributable to a casino operator misreading the mechanical meters, firmware models, serials, checksums, etc. Additionally, another advantage of the machine readable content display techniques described herein is that such techniques may be used to mask or obscure the display information from interpretation by human observers, while allowing the display information to be interpreted by an electronic reading device.

The following example is intended to help illustrate at least some of the advantages and benefits of the techniques described herein. In this example, it is assumed that a large jackpot win event (such as, for example, a Megabucks™ jackpot) has occurred at a particular gaming machine.

Typically, when a jackpot win exceeding a specified value occurs at a particular gaming machine, a casino operator or attendant is often required to verify the version(s) of firmware and hardware that are installed at the gaming machine before awarding the jackpot payout to the player. Verification of the firmware and/or hardware versions may involve interrogating the model number, serial number and/or checksums of selected firmware within the gaming machine.

Traditionally, in order for a casino operator to verify version(s) of firmware and hardware that are installed at the gaming machine, the operator typically required to go to the physical location of the gaming machine, and perform input operations at the gaming machine to cause the gaming machine to display on the gaming machine display desired firmware model numbers, serial numbers, and/or checksums. Viewing the displayed information, the casino operator then manually records (e.g., writes down) the displayed numbers, and visually compares the written information to numbers that have been obtained from a trusted source (such as, for example, system database in the casino network). Assuming that no errors have been made by the casino operator, and that the comparative numbers match, the player may then be allowed to receive the jackpot award.

It will be appreciated that the above-described traditional technique for verifying jackpot awards is susceptible to errors which may be attributable to the casino operator. In at least one embodiment, such errors may be reduced or eliminated by providing additional functionality at the gaming machine to enable the gaming machine to encode selected firmware model numbers, serial numbers, and/or checksums into barcode data, which may be displayed on the gaming machine display using alpha-numeric and/or graphical symbols. The displayed barcode data may then be scanned and recorded by the casino operator via the use of a mobile scanning device. In one embodiment, and recorded barcode data may be provided by the scanning device to a computer system which is operable to decode the barcode data in order to extract the firmware model numbers, serial numbers, and/or checksums which were generated at the gaming machine. The computer system may also be operable to validate the extracted information, for example, by comparing the extracted numbers with corresponding numbers that have been obtained from a trusted source, and to indicate to the casino operator the results of the comparison. In at least one embodiment, the mobile scanning device may be operable to perform at least a portion of the functions relating to decoding of the barcode information and/or the validating of the version(s) of firmware, software, and/or hardware that are installed at the gaming machine.

### Example Gaming Machine Embodiments

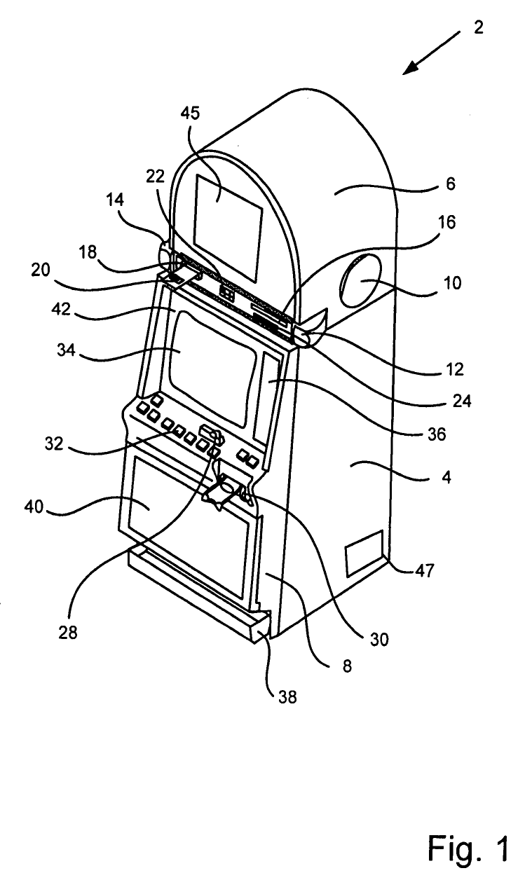

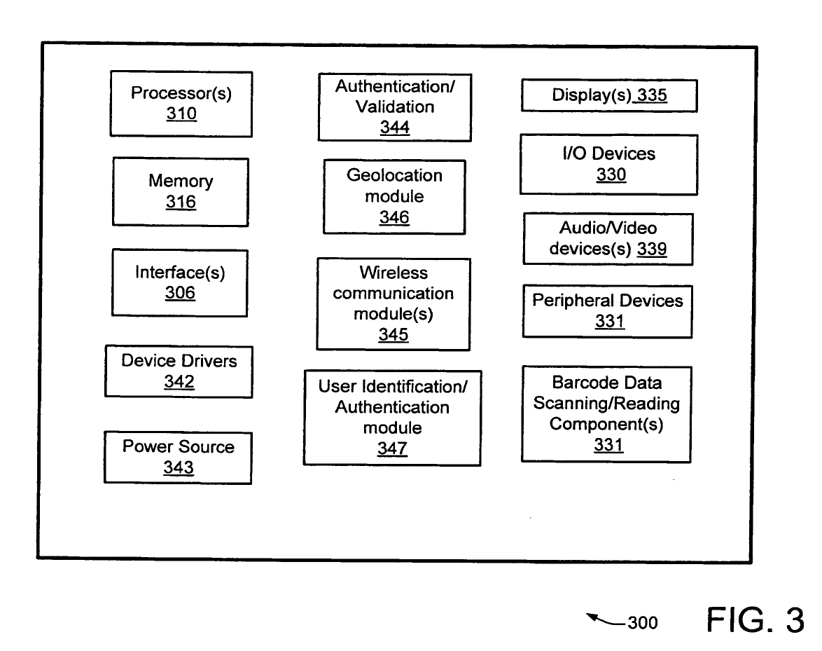

FIG. 1 shows a perspective view of an exemplary gaming machine 2 in accordance with a specific example of an embodiment. As illustrated in the example of FIG. 1, machine 2 includes a main cabinet 4, which generally surrounds the machine interior (illustrated, for example, in FIG. 3) and is viewable by users. The main cabinet includes a main door 8 on the front of the machine, which opens to provide access to the interior of the machine. In some embodiments, gaming machine 2 may include at least one window 47 for allowing the casino operator to view at least a portion of the hard meters located within the gaming machine cabinet. It will be appreciated that, in alternate embodiments, the size and/or location of window 47 may differ then that illustrated in FIG. 1.

As shown in the embodiment of FIG. 1, attached to the main door are player-input switches or buttons 32, a coin acceptor 28, and a bill validator 30, a coin tray 38, and a belly glass 40. Viewable through the main door is a video display monitor 34 and an information panel 36. The display monitor 34 will typically be a cathode ray tube, high resolution flat-panel LCD, or other conventional electronically controlled video display device. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. According to a specific embodiment, the devices may be controlled by code executed by a master gaming controller housed inside the main cabinet 4 of the machine 2. In specific embodiments where it may be required that the code be periodically configured and/or authenticated in a secure manner, example embodiments may be used for accomplishing such tasks.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

As illustrated in the example of FIG. 1, the gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 45. The ticket printer 18 may be used to print tickets for a cashless ticketing system. Further, the top box 6 may house different or additional devices not illustrated in FIG. 1. For example, the top box may include a bonus wheel or a back-lit silk screened panel which may be used to add bonus features to the game being played on the gaming machine. As another example, the top box may include a display for a progressive jackpot offered on the gaming machine. During a game, these devices are controlled and powered, in part, by circuitry (e.g. a master gaming controller) housed within the main cabinet 4 of the machine 2.

It will be appreciated that gaming machine 2 is but one example from a wide range of gaming machine designs relating to example embodiments. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that example embodiments, as described below, can be deployed on most any gaming machine now available or hereafter developed.

Some preferred gaming machines of the present assignee are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

For example, a watchdog timer is normally used in International Game Technology (IGT) gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

IGT gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modern general-purpose computers include voltage monitoring circuitry, these types of circuits only report voltage status to the operating software. Out of tolerance voltages can cause software malfunction, creating a potential uncontrolled condition in the gaming computer. Gaming machines of the present assignee typically have power supplies with tighter voltage margins than that required by the operating circuitry. In addition, the voltage monitoring circuitry implemented in IGT gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for IGT slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed has been stored. This feature allows the game to recover operation to the current state of play in the event of a malfunction, loss of power, etc that occurred just prior to the malfunction. In at least one embodiment, the gaming machine is configured or designed to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

In order to ensure the success of atomic transactions relating to critical information to be stored in the gaming machine memory before a failure event (e.g., malfunction, loss of power, etc.), it is preferable that memory be used which includes one or more of the following criteria: direct memory access capability; data read/write capability which meets or exceeds minimum read/write access characteristics (such as, for example, at least 5.08 Mbytes/sec (Read) and/or at least 38.0 Mbytes/sec (Write)). Devices which meet or exceed the above criteria may be referred to as “fault-tolerant” memory devices, whereas it is which the above criteria may be referred to as “fault non-tolerant” memory devices.

Typically, battery backed RAM devices may be configured or designed to function as fault-tolerant devices according to the above criteria, whereas flash RAM and/or disk drive memory are typically not configurable to function as fault-tolerant devices according to the above criteria. Accordingly, battery backed RAM devices are typically used to preserve gaming machine critical data, although other types of non-volatile memory devices may be employed. These memory devices are typically not used in typical general-purpose computers.

Thus, in at least one embodiment, the gaming machine is configured or designed to store critical information in fault-tolerant memory (e.g., battery backed RAM devices) using atomic transactions. Further, in at least one embodiment, the fault-tolerant memory is able to successfully complete all desired atomic transactions (e.g., relating to the storage of gaming machine critical information) within a time period of 200 milliseconds (ms) or less. In at least one embodiment, the time period of 200 ms represents a maximum amount of time for which sufficient power may be available to the various gaming machine components after a power outage event has occurred at the gaming machine.

As described previously, the gaming machine may not advance from a first state to a second state until critical information that allows the first state to be reconstructed has been atomically stored. This feature allows the game to recover operation to the current state of play in the event of a malfunction, loss of power, etc that occurred just prior to the malfunction. After the state of the gaming machine is restored during the play of a game of chance, game play may resume and the game may be completed in a manner that is no different than if the malfunction had not occurred. Thus, for example, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion. Further details of a state based gaming system, recovery from malfunctions and game history are described in U.S. Pat. No. 6,804,763, titled “High Performance Battery Backed RAM Interface”, U.S. Pat. No. 6,863,608, titled “Frame Capture of Actual Game Play,” U.S. application Ser. No. 10/243,104, titled, “Dynamic NV-RAM,” and U.S. application Ser. No. 10/758,828, titled, “Frame Capture of Actual Game Play,” each of which is incorporated by reference and for all purposes.

Another feature of gaming machines, such as IGT gaming computers, is that they often include unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, IGT's Netplex is a proprietary communication protocol used for serial communication between gaming devices. As another example, SAS is a communication protocol used to transmit information, such as metering information, from a gaming machine to a remote device. Often SAS is used in conjunction with a player tracking system.

IGT gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into an IGT gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices and/or trusted memory sources are preferably included in an IGT gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms included in the trusted device, the gaming machine is allowed to verify the authenticity of additional code and data that may be located in the gaming computer assembly, such as code and data stored on hard disk drives. A few details related to trusted memory devices that may be used in example embodiments are described in U.S. Pat. No. 6,685,567, filed Aug. 8, 2001 and titled “Process Verification,” and U.S. patent application Ser. No. 11/221,314, titled “Data Pattern Verification in a Gaming Machine Environment,” filed Sep. 6, 2005, each of which is incorporated herein by reference in its entirety and for all purposes.

In at least one embodiment, at least a portion of the trusted memory devices/sources may correspond to memory which cannot easily be altered (e.g., “unalterable memory”) such as, for example, EPROMS, PROMS, Bios, Extended Bios, and/or other memory sources which are able to be configured, verified, and/or authenticated (e.g., for authenticity) in a secure and controlled manner.

According to a specific implementation, when a trusted information source is in communication with a remote device via a network, the remote device may employ a verification scheme to verify the identity of the trusted information source. For example, the trusted information source and the remote device may exchange information using public and private encryption keys to verify each other's identities. In another example of an embodiment, the remote device and the trusted information source may engage in methods using zero knowledge proofs to authenticate each of their respective identities. Details of zero knowledge proofs that may be used with example embodiments are described in US publication no. 2003/0203756, by Jackson, filed on Apr. 25, 2002 and entitled, “Authentication in a Secure Computerized Gaming System”, which is incorporated herein in its entirety and for all purposes.

Gaming devices storing trusted information may utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Additional details relating to trusted memory devices/sources are described in U.S. patent application Ser. No. 11/078,966, entitled “SECURED VIRTUAL NETWORK IN A GAMING ENVIRONMENT”, naming Nguyen et al. as inventors, filed on Mar. 10, 2005, herein incorporated in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, IGT gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present. Details using a mass storage device that may be used with example embodiments are described, for example, in U.S. Pat. No. 6,149,522, herein incorporated by reference in its entirety for all purposes.

Returning to the example of FIG. 1, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 45 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights behind the belly glass 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

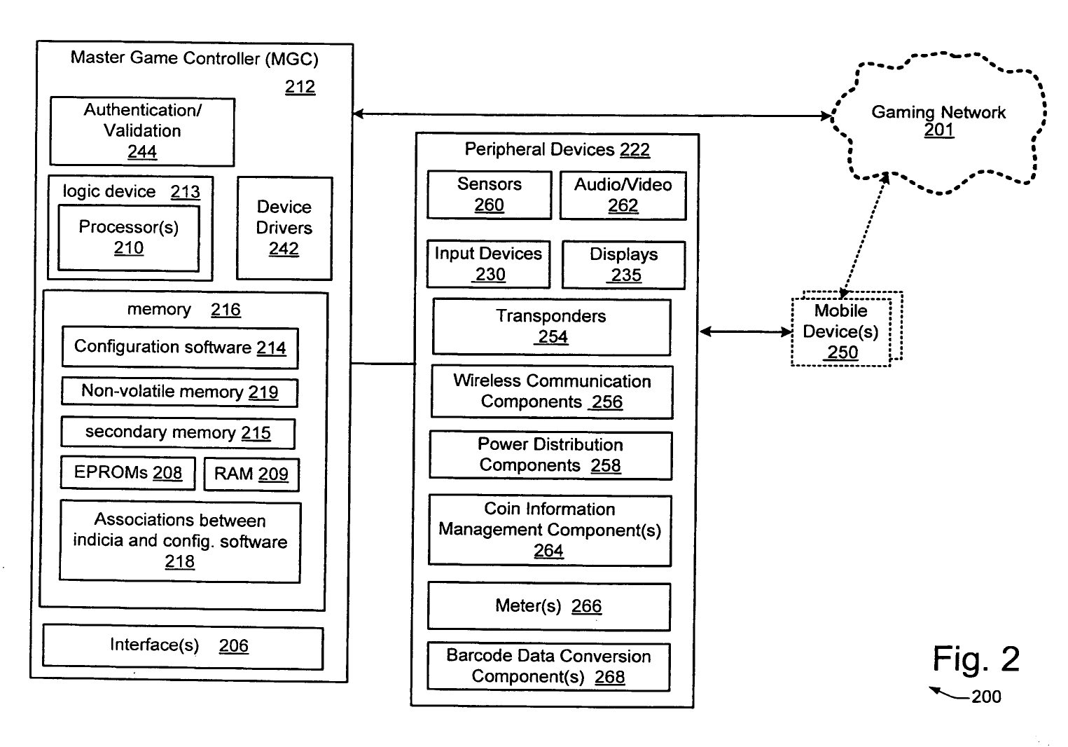

FIG. 2 is a simplified block diagram of an exemplary gaming machine 200 in accordance with a specific embodiment. As illustrated in the embodiment of FIG. 2, gaming machine 200 includes at least one processor 210, at least one interface 206, and memory 216.

In one implementation, processor 210 and master game controller 212 are included in a logic device 213 enclosed in a logic device housing. The processor 210 may include any conventional processor or logic device configured to execute software allowing various configuration and reconfiguration tasks such as, for example: a) communicating with a remote source via communication interface 206, such as a server that stores authentication information or games; b) converting signals read by an interface to a format corresponding to that used by software or memory in the gaming machine; c) accessing memory to configure or reconfigure game parameters in the memory according to indicia read from the device; d) communicating with interfaces, various peripheral devices 222 and/or I/O devices; e) operating peripheral devices 222 such as, for example, card readers, paper ticket readers, etc.; f) operating various I/O devices such as, for example, displays 235, input devices 230; etc. For instance, the processor 210 may send messages including game play information to the displays 235 to inform players of cards dealt, wagering information, and/or other desired information.

The gaming machine 200 also includes memory 216 which may include, for example, volatile memory (e.g., RAM 209), non-volatile memory 219 (e.g., disk memory, FLASH memory, EPROMs, etc.), unalterable memory (e.g., EPROMs 208), etc. The memory may be configured or designed to store, for example: 1) configuration software 214 such as all the parameters and settings for a game playable on the gaming machine; 2) associations 218 between configuration indicia read from a device with one or more parameters and settings; 3) communication protocols allowing the processor 210 to communicate with peripheral devices 222 and I/O devices 211; 4) a secondary memory storage device 215 such as a non-volatile memory device, configured to store gaming software related information (the gaming software related information and memory may be used to store various audio files and games not currently being used and invoked in a configuration or reconfiguration); 5) communication transport protocols (such as, for example, TCP/IP, USB, Firewire, IEEE1394, Bluetooth, IEEE 802.11x (IEEE 802.11 standards), hiperlan/2, HomeRF, etc.) for allowing the gaming machine to communicate with local and non-local devices using such protocols; etc. In one implementation, the master game controller 212 communicates using a serial communication protocol. A few examples of serial communication protocols that may be used to communicate with the master game controller include but are not limited to USB, RS-232 and Netplex (a proprietary protocol developed by IGT, Reno, Nev.).

A plurality of device drivers 242 may be stored in memory 216. Example of different types of device drivers may include device drivers for gaming machine components, device drivers for peripheral components 222, etc. Typically, the device drivers 242 utilize a communication protocol of some type that enables communication with a particular physical device. The device driver abstracts the hardware implementation of a device. For example, a device drive may be written for each type of card reader that may be potentially connected to the gaming machine. Examples of communication protocols used to implement the device drivers include Netplex, USB, Serial, Ethernet 275, Firewire, I/O debouncer, direct memory map, serial, PCI, parallel, RF, Bluetooth™, near-field communications (e.g., using near-field magnetics), 802.11 (WiFi), etc. Netplex is a proprietary IGT standard while the others are open standards. According to a specific embodiment, when one type of a particular device is exchanged for another type of the particular device, a new device driver may be loaded from the memory 216 by the processor 210 to allow communication with the device. For instance, one type of card reader in gaming machine 200 may be replaced with a second type of card reader where device drivers for both card readers are stored in the memory 216.

In some embodiments, the software units stored in the memory 216 may be upgraded as needed. For instance, when the memory 216 is a hard drive, new games, game options, various new parameters, new settings for existing parameters, new settings for new parameters, device drivers, and new communication protocols may be uploaded to the memory from the master game controller 212 or from some other external device. As another example, when the memory 216 includes a CD/DVD drive including a CD/DVD designed or configured to store game options, parameters, and settings, the software stored in the memory may be upgraded by replacing a first CD/DVD with a second CD/DVD. In yet another example, when the memory 216 uses one or more flash memory 219 or EPROM 208 units designed or configured to store games, game options, parameters, settings, the software stored in the flash and/or EPROM memory units may be upgraded by replacing one or more memory units with new memory units which include the upgraded software. In another embodiment, one or more of the memory devices, such as the hard-drive, may be employed in a game software download process from a remote software server.

In some embodiments, the gaming machine 200 may also include various authentication and/or validation components 244 which may be used for authenticating/validating specified gaming machine components such as, for example, hardware components, software components, firmware components, information stored in the gaming machine memory 216, etc. Examples of various authentication and/or validation components are described in U.S. Pat. No. 6,620,047, entitled, “ELECTRONIC GAMING APPARATUS HAVING AUTHENTICATION DATA SETS,” incorporated herein by reference in its entirety for all purposes.

Peripheral devices 222 may include several device interfaces such as, for example: transponders 254, wire/wireless power distribution components 258, input device(s) 230, sensors 260, audio and/or video devices 262 (e.g., cameras, speakers, etc.), transponders 254, wireless communication components 256, wireless power components 258, coin information management component(s) 264, meters 266 (which, for example, may include hard meters and/or soft meters), barcode data conversion component(s) 268, etc.

Sensors 260 may include, for example, optical sensors, pressure sensors, RF sensors, Infrared sensors, image sensors, thermal sensors, biometric sensors, etc. Such sensors may be used for a variety of functions such as, for example detecting the presence and/or identity of various persons (e.g., players, casino employees, etc.), devices (e.g., mobile devices), and/or systems within a predetermined proximity to the gaming machine. In one implementation, at least a portion of the sensors 260 and/or input devices 230 may be implemented in the form of touch keys selected from a wide variety of commercially available touch keys used to provide electrical control signals. Alternatively, some of the touch keys may be implemented in another form which are touch sensors such as those provided by a touchscreen display. For example, in at least one implementation, the gaming machine player displays and/or mobile device displays may include input functionality for allowing players to provide desired information (e.g., game play instructions and/or other input) to the gaming machine, game table and/or other gaming system components using the touch keys and/or other player control sensors/buttons. Additionally, such input functionality may also be used for allowing players to provide input to other devices in the casino gaming network (such as, for example, player tracking systems, side wagering systems, etc.)

Wireless communication components 256 may include one or more communication interfaces having different architectures and utilizing a variety of protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetic communication protocols, etc. The communication links may transmit electrical, electromagnetic or optical signals which carry digital data streams or analog signals representing various types of information.

Power distribution components 258 may include, for example, components or devices which are operable for providing wired or wireless power to other devices. For example, in one implementation, the power distribution components 258 may include a magnetic induction system which is adapted to provide wireless power to one or more mobile devices near the gaming machine. In one implementation, a mobile device docking region may be provided which includes a power distribution component that is able to recharge a mobile device without requiring metal-to-metal contact.

According to different embodiments, meters 266 may include hard meters and/or soft meters, which, for example, may be configured or designed to record various types of gaming machine related information such as, for example, Coin In information, Coin Out information, Jackpot information, Games Played, Game Won, Game Lost, etc. In at least one embodiment, at least a portion of the hard meters may be configured or designed to display meter information which includes alphanumeric (e.g., numbers, letters, ASCII characters, etc.) and/or graphical symbols. According to specific embodiments, at least a portion of the displayed meter information may include machine readable information (e.g., barcode data) which, for example, may be read by any capable electronic scanning device.

In at least one embodiment, coin information management component(s) 264 may include various types of functionality, which, for example, may include, but not be limited to, one or more of the following (or combination thereof): functionality for tracking and managing coin information (e.g., Coin In information, Coin Out information, Jackpot information, etc.) relating to the gaming machine; functionality for providing coin information (and/or other types of gaming machine information) to one or more meters (which, for example, may include hard meters and/or soft meters); functionality for managing and/or controlling meter operations and/or activities; etc.

In at least one embodiment, barcode data conversion component(s) 268 may include functionality for generating machine readable display data (e.g., barcode data) which may be displayed (e.g., via an electronic display device, and/or via a mechanical display mechanism) at the gaming machine using alpha-numeric and/or graphical symbols. In one embodiment barcode data conversion component(s) 268 may include functionality for converting and/or encoding various types of gaming machine information into machine readable display data according to one or more specified formats. In some embodiments, barcode data conversion component(s) 268 may also include functionality for rendering the machine readable display data for display at an electronic display of the gaming machine.

In other embodiments (not shown) other peripheral devices include: player tracking devices, card readers, bill validator/paper ticket readers, etc. Such devices may each comprise resources for handling and processing configuration indicia such as a microcontroller that converts voltage levels for one or more scanning devices to signals provided to processor 210. In one embodiment, application software for interfacing with peripheral devices 222 may store instructions (such as, for example, how to read indicia from a portable device) in a memory device such as, for example, non-volatile memory, hard drive or a flash memory.

In at least one implementation, the gaming machine may include card readers such as used with credit cards, or other identification code reading devices to allow or require player identification in connection with play of the card game and associated recording of game action. Such a user identification interface can be implemented in the form of a variety of magnetic card readers commercially available for reading a user-specific identification information. The user-specific information can be provided on specially constructed magnetic cards issued by a casino, or magnetically coded credit cards or debit cards frequently used with national credit organizations such as VISA™, MASTERCARD™, banks and/or other institutions.

The gaming machine may include other types of participant identification mechanisms which may use a fingerprint image, eye blood vessel image reader, or other suitable biological information to confirm identity of the user. Still further it is possible to provide such participant identification information by having the dealer manually code in the information in response to the player indicating his or her code name or real name. Such additional identification could also be used to confirm credit use of a smart card, transponder, and/or player's mobile device.

It will be apparent to those skilled in the art that other memory types, including various computer readable media, may be used for storing and executing program instructions pertaining to the operation EGMs described herein. Because such information and program instructions may be employed to implement the systems/methods described herein, example embodiments may relate to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Example embodiments may also be embodied in a carrier wave traveling over an appropriate medium such as airwaves, optical lines, electric lines, etc. Examples of program instructions include both machine code, such as produced by a compiler, and files including higher level code that may be executed by the computer using an interpreter.

Additional details about other gaming machine architectures, features and/or components are described, for example, in U.S. patent application Ser. No. 10/040,239, entitled, “GAME DEVELOPMENT ARCHITECTURE THAT DECOUPLES THE GAME LOGIC FROM THE GRAPHICS LOGIC,” and published on Apr. 24, 2003 as U.S. Patent Publication No. 20030078103, incorporated herein by reference in its entirety for all purposes.

FIG. 3 is a simplified block diagram of a mobile device 300 in accordance with a specific example of an embodiment. As illustrated in the example of FIG. 3 mobile device 300 may include a variety of components, modules and/or systems for providing various functionality. For example, as illustrated in FIG. 3, mobile device 300 may include, but is not limited to, one or more of the following (or combination thereof):
At least one processor 310. In at least one embodiment, the processor(s) 310 may include functionality similar to at least a portion of functionality implemented by one or more electronic gaming machines such as those described herein.
Memory 316, which, for example, may include volatile memory (e.g., RAM), non-volatile memory (e.g., disk memory, FLASH memory, EPROMs, etc.), unalterable memory, and/or other types of memory. In at least one implementation, the memory 316 may include functionality similar to at least a portion of functionality implemented by one or more electronic gaming machine memory devices such as those described herein.
Interface(s) 306 which, for example, may include wired interfaces and/or wireless interfaces. In at least one implementation, the interface(s) 306 may include functionality similar to at least a portion of functionality implemented by one or more electronic gaming machine interfaces such as those described herein. For example, in at least one implementation, the wireless communication interface(s) may be configured or designed to communicate with selected electronic game tables, electronic gaming machines, remote servers, base stations, other wireless devices (e.g., PDAs, cell phones, player tracking transponders, etc.), etc. Such wireless communication may be implemented using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Device driver(s) 342. In at least one implementation, the device driver(s) 342 may include functionality similar to at least a portion of functionality implemented by one or more electronic gaming machine driver devices such as those described herein.
At least one power source 343. In at least one implementation, the power source may include at least one mobile power source (e.g., battery) for allowing the mobile device to operate in a wireless and/or mobile environment. For example, in one implementation, the power source 343 may be implemented using a rechargeable, thin-film type battery. Further, in embodiments where it is desirable for the device to be flexible, the power source 343 may be designed to be flexible.
Authentication/validation components 344 which, for example, may be used for authenticating and/or validating local hardware and/or software components, hardware/software components residing at a remote device, game play information, wager information, user information and/or identity, etc. Examples of various authentication and/or validation components are described in U.S. Pat. No. 6,620,047, entitled, “ELECTRONIC GAMING APPARATUS HAVING AUTHENTICATION DATA SETS,” incorporated herein by reference in its entirety for all purposes.
Geolocation module 346 which, for example, may be configured or designed to acquire geolocation information from remote sources and use the acquired geolocation information to determine information relating to a relative and/or absolute position of the mobile device. For example, in one implementation, the geolocation module 346 may be adapted to receive GPS signal information for use in determining the position or location of the mobile device. In another implementation, the geolocation module 346 may be adapted to receive multiple wireless signals from multiple remote devices (e.g., gaming machines, servers, wireless access points, etc.) and use the signal information to compute position/location information relating to the position or location of the mobile device.
Wireless communication module(s) 345. In one implementation, the wireless communication module 345 may be configured or designed to communicate with external devices using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
User Identification module 347. In one implementation, the User Identification module may be adapted to determine the identity of the current user or owner of the mobile device. For example, in one embodiment, the current user may be required to perform a log in process at the mobile device in order to access one or more features. Alternatively, the mobile device may be adapted to automatically determine the identity of the current user based upon one or more external signals such as, for example, an RFID tag or badge worn by the current user which provides a wireless signal to the mobile device for determining the identity of the current user. In at least one implementation, various security features may be incorporated into the mobile device to prevent unauthorized users from accessing confidential or sensitive information.
One or more display(s) 335. According to various embodiments, such display(s) may be implemented using, for example, LCD display technology, OLED display technology, and/or other types of conventional display technology. In at least one implementation, display(s) 335 may be adapted to be flexible or bendable. Additionally, in at least one embodiment the information displayed on display(s) 335 may utilize e-ink technology (such as that available from E Ink Corporation, Cambridge, Mass., www.eink.com), or other suitable technology for reducing the power consumption of information displayed on the display(s) 335.
One or more user I/O Device(s) 330 such as, for example, keys, buttons, scroll wheels, cursors, touchscreen sensors, audio command interfaces, magnetic strip reader, optical scanner, etc.
Audio/Video device(s) 339 which, for example, may include cameras, speakers, microphones, media presentation components, wireless transmitter/receiver devices for enabling wireless audio and/or visual communication between the mobile device 300 and remote devices (e.g., radios, telephones, computer systems, etc.). For example, in one implementation, the audio system may include componentry for enabling the mobile device to function as a cell phone or two-way radio device. such as, for example, components for displaying audio/visual media.
Barcode data scanning/reading components 331. In at least one embodiment, the barcode data scanning/reading components 331 may include a variety of components and/or subsystems which, for example, may include, but not limited to, one or more of the following (or combination thereof): an imaging subsystem, a scanning subsystem, a photodetecting subsystem, an RFID reading engine, etc. In at least one embodiment, the imaging subsystem may include an image capture device, such as, for example, an image sensor array which, for example, may include one- or two-dimensional array(s) of CCDs. The image sensor array may be operable to capture an image of displayed machine readable data, and to transform the captured image into digital image data. The scanning subsystem may include one or more illumination sources, a scanning mechanism, and photodetecting subsystem. According to specific embodiments, the illumination source(s) may be configured or designed to emit different forms of light having different frequencies and/or wavelengths. According to specific embodiments, the illumination source may include a plurality of different light sources which, for example, may include, but are not limited to, one or more of the following (or combination thereof): a laser light source (such as a semiconductor laser diode); a visible light source; an infrared light source; a black light source (e.g., capable of emitting black light), etc. The photodetecting subsystem may include one or more photodetectors positioned to receive modulated and/or reflected light. In at least one embodiment, different photodetectors may be configured or designed to detect the different types of light (e.g., visible light, laser light, infrared light, black light, etc.) having different frequency and/or wavelength characteristics. In at least one embodiment, the photodetecting subsystem may be operable to detect light returned from the machine readable data, and may further be operable to transform the received light signals into an analog or digital scan profile. In at least one embodiment, the RFID reading engine may be operable to read information from an RFID tag.
Other types of peripheral devices 331 which may be useful to the users of such mobile devices, such as, for example: PDA functionality; memory card reader(s); fingerprint reader(s); image projection device(s); ticket reader(s); etc.

In one embodiment, mobile device 300 may be configured or designed to include functionality and/or features similar to those provided by the 1802 Vista Cordless barcode reader manufactured by Intermec, Inc. (see, e.g., www.Intermec.com).

In at least one embodiment, mobile device 300 may be operable to function as a barcode reader that is able to scan and read characters, barcodes, and/or other graphical symbols. In one embodiment, the barcode reader may be able to scan a combination of barcodes and characters in a single row or column, or in multiple rows/columns.

In some embodiments, the mobile device may be further operable to read and interpret numbers, letters, characters and/or symbols other than barcode symbols. For example, in at least one embodiment, the mobile device may be configured or designed as barcode reader which is also operable to perform character recognition. For example, in one embodiment, the barcode reader may be operable to read and/or decode meter data, serial number data, and/or checksum data which is not displayed in barcode format.

According to specific embodiments, the barcode reader may be operable to read machine readable data (e.g., in the form of alphanumeric symbols and/or graphical symbols) which may be displayed, for example, via a non-electronic display (e.g., a mechanical display, a physical display which includes characters/symbols printed thereon, etc.) and/or via an electronic display device (e.g., a CRT, LCD monitor, etc.).

Additional details relating to barcode scanning technology are described, for example, in at least the following references: U.S. patent application Ser. No. 11/601,419 (US Patent Publication No. 20070063049), by Anson et al., entitled “PORTABLE DATA READING DEVICE WITH INTEGRATED WEB SERVER FOR CONFIGURATION AND DATA EXTRACTION”, filed Nov. 17, 2006, the entirety of which is incorporated herein by reference for all purposes; and U.S. patent application Ser. No. 11/509,303, (US Patent Publication No. 20070051812), by Lopez et al., entitled “METHOD AND APPARATUS EMPLOYING IMAGING AND/OR SCANNING FOR READING MACHINE-READABLE SYMBOLS SUCH AS BARCODE SYMBOLS”, filed Aug. 23, 2006, the entirety of which is incorporated herein by reference for all purposes.

### Other System Embodiments

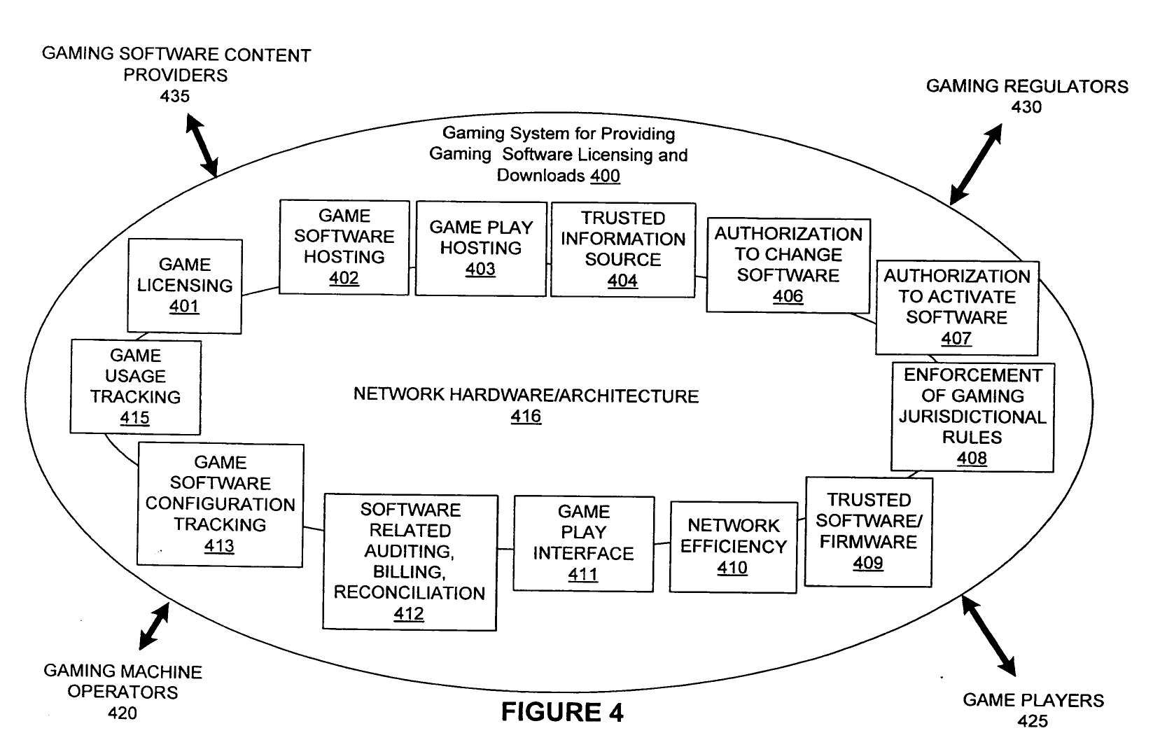

FIG. 4 shows a block diagram illustrating components of a gaming system 400 which may be used for implementing various aspects of example embodiments. In FIG. 4, the components of a gaming system 400 for providing game software licensing and downloads are described functionally. The described functions may be instantiated in hardware, firmware and/or software and executed on a suitable device. In the system 400, there may be many instances of the same function, such as multiple game play interfaces 411. Nevertheless, in FIG. 4, only one instance of each function is shown. The functions of the components may be combined. For example, a single device may comprise the game play interface 411 and include trusted memory devices or sources 409.

The gaming system 400 may receive inputs from different groups/entities and output various services and or information to these groups/entities. For example, game players 425 primarily input cash or indicia of credit into the system, make game selections that trigger software downloads, and receive entertainment in exchange for their inputs. Game software content providers (e.g., 435) provide game software for the system and may receive compensation for the content they provide based on licensing agreements with the gaming machine operators. Gaming machine operators select game software for distribution, distribute the game software on the gaming devices in the system 400, receive revenue for the use of their software and compensate the gaming machine operators. The gaming regulators 430 may provide rules and regulations that must be applied to the gaming system and may receive reports and other information confirming that rules are being obeyed.

In the following paragraphs, details of each component and some of the interactions between the components are described with respect to FIG. 4. The game software license host 401 may be a server connected to a number of remote gaming devices that provides licensing services to the remote gaming devices. For example, in other embodiments, the license host 401 may 1) receive token requests for tokens used to activate software executed on the remote gaming devices, 2) send tokens to the remote gaming devices, 3) track token usage and 4) grant and/or renew software licenses for software executed on the remote gaming devices. The token usage may be used in utility based licensing schemes, such as a pay-per-use scheme.

In another embodiment, a game usage-tracking host 415 may track the usage of game software on a plurality of devices in communication with the host. The game usage-tracking host 415 may be in communication with a plurality of game play hosts and gaming machines. From the game play hosts and gaming machines, the game usage tracking host 415 may receive updates of an amount that each game available for play on the devices has been played and on amount that has been wagered per game. This information may be stored in a database and used for billing according to methods described in a utility based licensing agreement.

The game software host 402 may provide game software downloads, such as downloads of game software or game firmware, to various devious in the game system 400. For example, when the software to generate the game is not available on the game play interface 411, the game software host 402 may download software to generate a selected game of chance played on the game play interface. Further, the game software host 402 may download new game content to a plurality of gaming machines via a request from a gaming machine operator.

In one embodiment, the game software host 402 may also be a game software configuration-tracking host 413. The function of the game software configuration-tracking host is to keep records of software configurations and/or hardware configurations for a plurality of devices in communication with the host (e.g., denominations, number of paylines, paytables, max/min bets). Details of a game software host and a game software configuration host that may be used with example embodiments are described in co-pending U.S. Pat. No. 6,645,077, by Rowe, entitled, “Gaming Terminal Data Repository and Information System,” filed Dec. 21, 2000, which is incorporated herein in its entirety and for all purposes.

A game play host device 403 may be a host server connected to a plurality of remote clients that generates games of chance that are displayed on a plurality of remote game play interfaces 411. For example, the game play host device 403 may be a server that provides central determination for a bingo game play played on a plurality of connected game play interfaces 411. As another example, the game play host device 403 may generate games of chance, such as slot games or video card games, for display on a remote client. A game player using the remote client may be able to select from a number of games that are provided on the client by the host device 403. The game play host device 403 may receive game software management services, such as receiving downloads of new game software, from the game software host 402 and may receive game software licensing services, such as the granting or renewing of software licenses for software executed on the device 403, from the game license host 401.

In particular embodiments, the game play interfaces or other gaming devices in the gaming system 400 may be portable devices, such as electronic tokens, cell phones, smart cards, tablet PC's and PDA's. The portable devices may support wireless communications and thus, may be referred to as wireless mobile devices. The network hardware architecture 416 may be enabled to support communications between wireless mobile devices and other gaming devices in gaming system. In one embodiment, the wireless mobile devices may be used to play games of chance.

The gaming system 400 may use a number of trusted information sources. Trusted information sources 404 may be devices, such as servers, that provide information used to authenticate/activate other pieces of information. CRC values used to authenticate software, license tokens used to allow the use of software or product activation codes used to activate to software are examples of trusted information that might be provided from a trusted information source 404. Trusted information sources may be a memory device, such as an EPROM, that includes trusted information used to authenticate other information. For example, a game play interface 411 may store a private encryption key in a trusted memory device that is used in a private key-public key encryption scheme to authenticate information from another gaming device.

When a trusted information source 404 is in communication with a remote device via a network, the remote device will employ a verification scheme to verify the identity of the trusted information source. For example, the trusted information source and the remote device may exchange information using public and private encryption keys to verify each other's identities. In another example of an embodiment, the remote device and the trusted information source may engage in methods using zero knowledge proofs to authenticate each of their respective identities. Details of zero knowledge proofs that may be used with example embodiments are described in US publication no. 2003/0203756, by Jackson, filed on Apr. 25, 2002 and entitled, “Authentication in a Secure Computerized Gaming System, which is incorporated herein in its entirety and for all purposes.

Gaming devices storing trusted information might utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

The gaming system 400 of example embodiments may include devices 406 that provide authorization to download software from a first device to a second device and devices 407 that provide activation codes or information that allow downloaded software to be activated. The devices, 406 and 407, may be remote servers and may also be trusted information sources. One example of a method of providing product activation codes that may be used with example embodiments is describes in previously incorporated U.S. Pat. No. 6,264,561.

A device 406 that monitors a plurality of gaming devices to determine adherence of the devices to gaming jurisdictional rules 408 may be included in the system 400. In one embodiment, a gaming jurisdictional rule server may scan software and the configurations of the software on a number of gaming devices in communication with the gaming rule server to determine whether the software on the gaming devices is valid for use in the gaming jurisdiction where the gaming device is located. For example, the gaming rule server may request a digital signature, such as CRC's, of particular software components and compare them with an approved digital signature value stored on the gaming jurisdictional rule server.

Further, the gaming jurisdictional rule server may scan the remote gaming device to determine whether the software is configured in a manner that is acceptable to the gaming jurisdiction where the gaming device is located. For example, a maximum bet limit may vary from jurisdiction to jurisdiction and the rule enforcement server may scan a gaming device to determine its current software configuration and its location and then compare the configuration on the gaming device with approved parameters for its location.

A gaming jurisdiction may include rules that describe how game software may be downloaded and licensed. The gaming jurisdictional rule server may scan download transaction records and licensing records on a gaming device to determine whether the download and licensing was carried out in a manner that is acceptable to the gaming jurisdiction in which the gaming device is located. In general, the game jurisdictional rule server may be utilized to confirm compliance to any gaming rules passed by a gaming jurisdiction when the information needed to determine rule compliance is remotely accessible to the server.

Game software, firmware or hardware residing a particular gaming device may also be used to check for compliance with local gaming jurisdictional rules. In one embodiment, when a gaming device is installed in a particular gaming jurisdiction, a software program including jurisdiction rule information may be downloaded to a secure memory location on a gaming machine or the jurisdiction rule information may be downloaded as data and utilized by a program on the gaming machine. The software program and/or jurisdiction rule information may used to check the gaming device software and software configurations for compliance with local gaming jurisdictional rules. In another embodiment, the software program for ensuring compliance and jurisdictional information may be installed in the gaming machine prior to its shipping, such as at the factory where the gaming machine is manufactured.

The gaming devices in game system 400 may utilize trusted software and/or trusted firmware. Trusted firmware/software is trusted in the sense that is used with the assumption that it has not been tampered with. For instance, trusted software/firmware may be used to authenticate other game software or processes executing on a gaming device. As an example, trusted encryption programs and authentication programs may be stored on an EPROM on the gaming machine or encoded into a specialized encryption chip. As another example, trusted game software, i.e., game software approved for use on gaming devices by a local gaming jurisdiction may be required on gaming devices on the gaming machine.

In example embodiments, the devices may be connected by a network 416 with different types of hardware using different hardware architectures. Game software can be quite large and frequent downloads can place a significant burden on a network, which may slow information transfer speeds on the network. For game-on-demand services that require frequent downloads of game software in a network, efficient downloading is essential for the service to viable. Thus, in example embodiments, network efficient devices 410 may be used to actively monitor and maintain network efficiency. For instance, software locators may be used to locate nearby locations of game software for peer-to-peer transfers of game software. In another example, network traffic may be monitored and downloads may be actively rerouted to maintain network efficiency.

One or more devices in example embodiments may provide game software and game licensing related auditing, billing and reconciliation reports to server 412. For example, a software licensing billing server may generate a bill for a gaming device operator based upon a usage of games over a time period on the gaming devices owned by the operator. In another example, a software auditing server may provide reports on game software downloads to various gaming devices in the gaming system 400 and current configurations of the game software on these gaming devices.

At particular time intervals, the software auditing server 412 may also request software configurations from a number of gaming devices in the gaming system. The server may then reconcile the software configuration on each gaming device. In one embodiment, the software auditing server 412 may store a record of software configurations on each gaming device at particular times and a record of software download transactions that have occurred on the device. By applying each of the recorded game software download transactions since a selected time to the software configuration recorded at the selected time, a software configuration is obtained. The software auditing server may compare the software configuration derived from applying these transactions on a gaming device with a current software configuration obtained from the gaming device. After the comparison, the software-auditing server may generate a reconciliation report that confirms that the download transaction records are consistent with the current software configuration on the device. The report may also identify any inconsistencies. In another embodiment, both the gaming device and the software auditing server may store a record of the download transactions that have occurred on the gaming device and the software auditing server may reconcile these records.

There are many possible interactions between the components described with respect to FIG. 4. Many of the interactions are coupled. For example, methods used for game licensing may affect methods used for game downloading and vice versa. For the purposes of explanation, details of a few possible interactions between the components of the system 400 relating to software licensing and software downloads have been described. The descriptions are selected to illustrate particular interactions in the game system 400. These descriptions are provided for the purposes of explanation only and are not intended to limit the scope of example embodiments described herein.

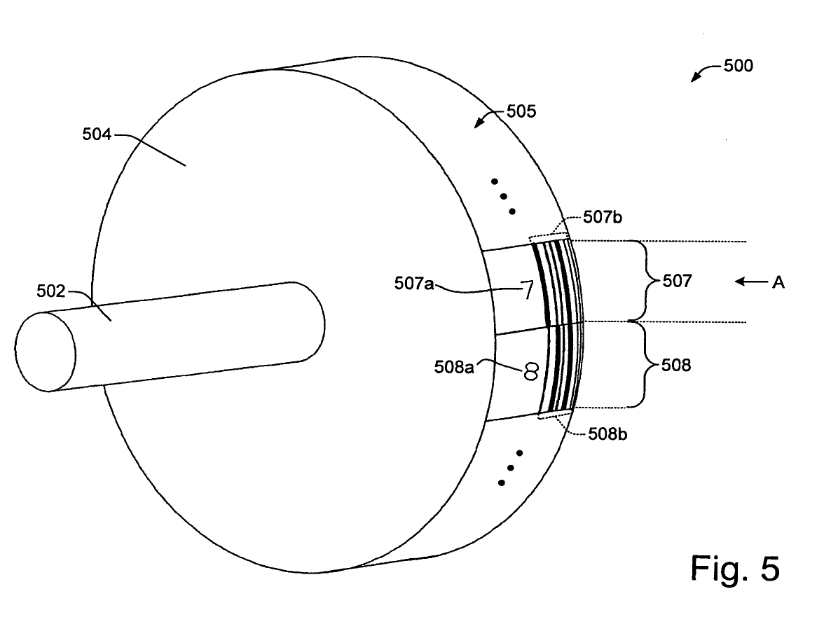

FIG. 5 shows an example of a portion 500 of a hard meter in accordance with a specific embodiment. As shown in the example of FIG. 5, hard meter portion 500 includes a rotatable cylinder or drum 504 having a display surface 505. In at least one embodiment, drum display surface 504 includes different portions of content (e.g., 507, 508) which, for example, may be printed onto display surface 505 or otherwise affixed thereto.

As shown in the example of FIG. 5, content portion 507 includes an alphanumeric portion 507a (which, in this example, corresponds to the number “7”), and a barcode portion 507b, which is displayed using a plurality of graphical symbols. In at least one embodiment, barcode portion 507b may be formatted for display in accordance with a variety of a different machine readable display formats such as, for example, barcode array formats, matrix array formats, etc. Additionally, although the barcode portions are illustrated using vertical lines, in at least some other embodiments the barcode data may be represented using horizontal lines.

In at least one embodiment, the displayed barcode portions may be used to represent various types of information that have been encoded into barcode data suitable for display according to a selected barcode display format. In one embodiment, the information represented by barcode portion 507b is identical to the information represented by alphanumeric portion 507a. Thus, for example, in one embodiment, a barcode scanning device capable of reading barcode portion 507b may decode the barcode data represented by barcode portion 507b as corresponding to the number “7”.

Similarly, as shown in the example of FIG. 5, content portion 508 includes an alphanumeric portion 508a (which, in this example, corresponds to the number “8”), and a barcode portion 508b, which is displayed using a plurality of graphical symbols. In at least one embodiment, the barcode data represented by barcode portion 508b is identical to the information represented by alphanumeric portion 508a. Thus, for example, in one embodiment, a barcode scanning device capable of reading barcode portion 508b may decode the barcode data represented by barcode portion 508b as corresponding to the number “8”.

It will be appreciated, however, that in other embodiments, the displayed barcode portions may be used to represent information other than or in addition to the information represented by its associated alphanumeric portion.

Although not illustrated in the example of FIG. 5, drum display surface 505 may include other portions of content distributed about the display surface. For example, in one embodiment, display surface 505 may be divided into ten equal sections, with each section consuming about 1/10 of the display surface. In at least one embodiment, each section of the display surface may be used to display content relating a different consecutive number within the range 0-9. Thus, for example, a first section of the display surface 505 may display alphanumeric data and/or barcode data representing the numeral “1”, a second section of the display surface 505 may display alphanumeric data and/or barcode data representing the numeral “2”, and so on. In one embodiment, the section of the display surface 505 between the values 9 and 1 may display alphanumeric data and/or barcode data representing the numeral “0”. Accordingly, in at least one embodiment, drum display surface 505 may include ten different portions of barcode content, wherein each portion of barcode content represents a respective number (and/or numbered position on that meter drum) from 0-9. In the example of FIG. 5, only two of the ten equal sections are shown, namely the sections representing the numerals “7” and “8”.

According to specific embodiments, the barcode content of display surface 505 may be read and recorded by a barcode scanner and/or other suitable electronic device. In this way, the data displayed on meter drum 504 may be read and recorded in significantly shorter time than conventional techniques. This results in improved resource allocation efficiency, for example, by reducing the amount of time required by a casino operator to perform gaming machine meter reading operations. Additionally, meter reading related errors may also be significantly reduced since, for example, the operator does not record the data by hand.

In alternate embodiments, the display surface of drum 504 may be divided into n sections, where n represents any integer greater than zero. For example, in one embodiment, display surface 505 may be divided into 12 equal sections, with each section representing a corresponding number from 0-11. In another embodiment, display surface 505 may be divided into 60 equal sections, with each section representing a corresponding number from 0-59. In a different embodiment, display surface 505 may be divided into 26 equal sections, with each section representing a corresponding letter from A-Z. Additionally, in some embodiments at least some sections may be of different dimensions, sizes, and/or shapes.

Additionally, in at least some embodiments, drum display surface 505 may include only barcode content and/or other types of machine readable content which may be read by an appropriately configured electronic device.

According to specific embodiments, drum 504 may be formed using a variety of different materials such as, for example, plastic and/or metal materials.

As illustrated in the example of FIG. 5, a drum 504 may be connected to a shaft 502. In one embodiment, shaft 502 may be used to mount the mechanical drum 504 within the meter assembly. Additionally, shaft 502 may be used to rotate drum 504, for example, in order to indicate a change of the current numerical value represented by drum 504. For example, in one embodiment, the hard meter may be configured or designed to monitor specific activity at the gaming machine, and to increment or decrement it's displayed meter data in response to detecting specific events and/or conditions. For example, referring to the example of FIG. 5, if it is assumed that the current value of meter drum 504 is indicated by the data displayed at position A (e.g., current value=7), and that it is desired to increment the displayed value of meter drum 504 by one, the hard meter may cause drum 504 to be rotated (e.g., by about 36 degrees) in a manner which results in content portion 508 (corresponding to the numeric value “8”) occupying the “current value” position as indicated, for example, at position A of FIG. 5.

In at least one embodiment, drum 504 may be one of several meter drums which collectively form all or part of the meter display. For example, in one embodiment, a coin counting meter assembly may include a total of seven meter drums. In one embodiment, each consecutive meter drum may be connected to the left next consecutive (e.g., adjacent) meter drum using an apparatus which, for example, provides that one full revolution of the relative right drum causes a one tenth revolution of the drum to the relative left. According to specific embodiments, each of the mechanical drums that make up the meter display may be connected together in the above-described manner.

In one embodiment, the right most meter drum of the meter display may be rotated (e.g., incremented or decremented) via the use of a solenoid (or other suitable devices commonly know to one having ordinary skill in the art). According to one embodiment, if the rightmost mechanical drum solenoid is energized n times (e.g., n=10), the next mechanical meter drum to the left will index 1/m (e.g., 1/10) of a revolution in order to change its currently displayed value.

It will be appreciated that, by including both alphanumeric data and barcode data on the meter drum display surface(s), the meter value may be scanned/read by an electronic device (such as, for example, a barcode scanner device) and/or may be manually read by a person such as, for example, a casino operator or attendant. In at least some embodiments, the barcode reader device may also be operable to perform character recognition in order, for example, to enable the barcode reader device to read meter data and/or serial number data (such as, for example, alphanumeric characters) that are not displayed in barcode format.

In the example of FIG. 5, the barcode content (e.g., 507b, 508b) is displayed using black and white symbols which are visible to the human eye in normal lighting conditions. In one embodiment “normal” lighting conditions includes lighting generated from commonly know visible light sources such as, for example, sunlight, incandescent light, fluorescent light, etc.

However, in at least one alternate embodiment, at least a portion of the displayed barcode content (e.g., displayed on display surface 505) may be configured or designed in such a way that it would be visible only using special (e.g., non-visible) illumination sources. In at least one embodiment, such “special” illumination sources may include one or more devices which are capable of emitting electromagnetic radiation which is not within the visible spectrum. Examples of special illumination sources may include, but are not limited to, one or more of the following (or combination thereof): black light spectrum illumination sources (e.g., illumination sources which emit wavelengths shorter than 400 nm, and/or wavelengths within the 400 nm-200 nm range); infrared spectrum illumination sources (e.g., illumination sources which emit wavelengths longer than 750 nm, and/or within the 750 nm-1000 nm range); Near infrared (NIR) spectrum illumination sources (e.g., illumination sources which emit wavelengths within the range of 750 nm-1400 nm); SWIR Short wavelength IR illumination sources (e.g., illumination sources which emit wavelengths within the range of 1.4-3 um); MWIR Mid Wavelength IR illumination sources (e.g., illumination sources which emit wavelengths within the range of 3-8 um); etc.

For example, in one embodiment, at least a portion of the displayed barcode content (e.g., displayed on display surface 505) may be printed using black light reflective material which is visible only when exposed to black light radiation. In one embodiment, the alphanumeric content (e.g., 507a, 508a) may be visible when it is illuminated under normal lighting conditions, but the barcode content (e.g., 507b, 508b) may not be visible under normal lighting conditions. However, when illuminated using a black light radiation source, the barcode content may be visible and/or may be detectable and readable by an appropriately configured barcode scanning device.

In a different embodiment, at least a portion of the displayed barcode content may be printed using infrared reflective material which is visible only when exposed to infrared radiation. In one embodiment, the alphanumeric content (e.g., 507a, 508a) may be visible when it is illuminated under normal lighting conditions, but the barcode content (e.g., 507b, 508b) may not be visible under normal lighting conditions. However, when illuminated using a infrared radiation source, the barcode content may be visible and/or may be detectable and readable by an appropriately configured barcode scanning device.

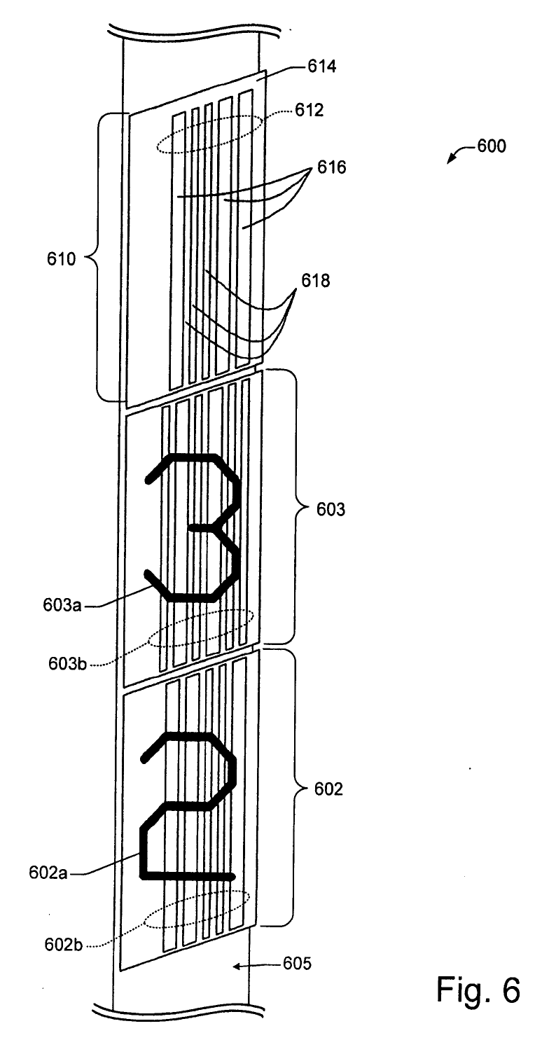

FIG. 6 shows an alternate example embodiment of a portion 600 of a display surface which may be implementing various aspects described herein. In one embodiment, portion 600 of FIG. 6 may correspond to a portion of a hard meter drum having a configuration similar to drum 504 of FIG. 5. For purposes of illustration and clarification, the display surface 605 is illustrated as a having a substantially flat shape. However, in other embodiments, display surface 605 may have a curved shape. In at least one embodiment, display surface 605 may have a curved shape similar to that illustrated by display surface 505 of FIG. 5.

In at least one embodiment, display portion 600 includes different portions of content (e.g., 602, 603, 610) which, for example, may be printed onto display surface 605. In alternate embodiments, at least a portion of the content displayed on display surface 605 printed on a label affixed to the display surface 605.

As shown in the example of FIG. 6, content portion 602 includes an alphanumeric portion 602a (which, in this example, corresponds to the numeral “2”), and a barcode portion 602b, which is displayed using a plurality of graphical symbols. In at least one embodiment, barcode portion 602b may be formatted for display in accordance with a variety of a different machine readable display formats such as, for example, barcode array formats, matrix array formats, etc. Additionally, although the barcode portions are illustrated using vertical lines, in at least some other embodiments the barcode data may be represented using horizontal lines.

In at least one embodiment, the displayed barcode portions may be used to represent various types of information that have been encoded into barcode data suitable for display according to a selected barcode display format. In one embodiment, the information represented by barcode portion 602b is identical to the information represented by alphanumeric portion 602a. Thus, for example, in one embodiment, a barcode scanning device capable of reading barcode portion 602b may decode the barcode data represented by barcode portion 602b as corresponding to the number “2”.

Similarly, as shown in the example of FIG. 6, content portion 603 includes an alphanumeric portion 603a (which, in this example, corresponds to the number “3”), and a barcode portion 603b, which is displayed using a plurality of graphical symbols. In at least one embodiment, the barcode data represented by barcode portion 603b is identical to the information represented by alphanumeric portion 603a. Thus, for example, in one embodiment, a barcode scanning device capable of reading barcode portion 603b may decode the barcode data represented by barcode portion 603b as corresponding to the number “3”.

It will be appreciated, however, that in other embodiments, the displayed barcode portions may be used to represent information other than or in addition to the information represented by its associated alphanumeric portion.

Although not illustrated in the example of FIG. 6, display surface 605 may include other portions of content distributed about the display surface. For example, in one embodiment, display surface 605 may be divided into ten equal sections, with each section consuming about 1/10 of the display surface. In at least one embodiment, each section of the display surface may be used to display content relating a different consecutive number within the range 0-9. Thus, for example, a first section of the display surface 605 may display alphanumeric data and/or barcode data representing the numeral “1”, a second section of the display surface 605 may display alphanumeric data and/or barcode data representing the numeral “2”, and so on. In one embodiment where the display surface forms a continuous loop, the section of the display surface 605 between the values 9 and 1 may display alphanumeric data and/or barcode data representing the numeral “0”.

According to specific embodiments, the barcode content of display surface 605 may be read and recorded by a barcode scanner and/or other suitable electronic device. In this way, the data displayed on meter drum 604 may be read and recorded in significantly shorter time than conventional techniques. This results in improved resource allocation efficiency, for example, by reducing the amount of time required by a casino operator to perform gaming machine meter reading operations. Additionally, meter reading related errors may also be significantly reduced since, for example, the operator does not record the data by hand.

In alternate embodiments, the display surface of drum 604 may be divided into n sections, where n represents any integer greater than zero. For example, in one embodiment, display surface 605 may be divided into 12 equal sections, with each section representing a corresponding number from 0-11. In another embodiment, display surface 605 may be divided into 60 equal sections, with each section representing a corresponding number from 0-59. In a different embodiment, display surface 605 may be divided into 26 equal sections, with each section representing a corresponding letter from A-Z. Additionally, in some embodiments at least some sections may be of different dimensions, sizes, and/or shapes.

Additionally, in at least some embodiments, display surface 605 may include only barcode content and/or other types of machine readable content which may be read by an appropriately configured electronic device.

According to specific embodiments, the display surface 605 and content displayed thereon may be comprised of one or more different layers of materials. For example, in at least one embodiment, the barcode content may be formed or deposited using at least one layer of material that is formed or deposited over the display surface 605. In at least one embodiment, the barcode content (e.g., 602b, 603b, 612) may be printed on the display surface using infrared reflective ink (such as, for example, AB820 Black ink which is available from Kawamura Chemical Co., www.kawamura-chemical.com). In other embodiments the barcode content (e.g., 602b, 603b, 612) may be printed on the display surface using UV or black light reflective inks such as, for example “invisible” inks. In at least one embodiment, the barcode content may be formed or deposited using at least one layer of material which includes microscopic glass spheres that have the capability of returning light rays to an observer.

According to specific embodiments, the barcode content may include different patterns, shapes, and/or symbols, which may be used to present the barcode data. For example, as illustrated in the example of FIG. 5, barcode content 612 includes “wide stripe” symbols 606 and “narrow stripe” symbols 608.

In at least one embodiment, one or more additional layers may be formed or deposited over the barcode content layer. For example, as illustrated in the example of FIG. 6, a filter layer (e.g., 614) may be formed or deposited over barcode content 612. In one embodiment, the filter layer may be configured or designed to be visible light reflective, and infrared light transmissive. For example, in one embodiment, the filter layer may be implemented using hot and cold dielectric mirrors such as those available from CVI Optical Materials (www.ocioptics.com). In one embodiment, the filter layer may be used to hide the barcodes from view in normal (e.g., visible) lighting conditions.

In another embodiment, the filter layer may be configured or designed to be visible light reflective, and black light transmissive. For example, in one embodiment, the filter layer may be implemented using, for example, Kodak IR Filter(s), Hoya infrared transmission filter(s), Brenner IR filter(s); and/or other suitable filters commonly known to one having ordinary skill in the art.

In at least one embodiment, the filter layer may be comprised of multiple different layers of materials which collectively form the filter layer.

In at least one embodiment, one or more additional layers of material may be formed or deposited over the filter layer. For example, in one embodiment, an alphanumeric layer of material may formed or deposited over the filter layer. According to specific embodiments, the alphanumeric layer may include number(s), letter(s), and/or symbol(s). For example, as illustrated in the example of FIG. 6, numbers (e.g., 602a, 603a) may be printed on top of the filter layer. In at least one embodiment, the number(s), letter(s), and/or symbol(s) may be printed using ink that is visible in normal lighting conditions (e.g., is visible when illuminated using a visible light source).

In at least one embodiment, the display surface 605 may also include a layer of infrared absorbing material. For example, in one embodiment where display surface 605 corresponds to the display surface of a meter drum, a layer of infrared absorbing material may be interposed between the drum display surface and the barcode content layer. In one embodiment, the layer of infrared absorbing material may be applied directly to the display surface of the drum. In at least one embodiment, the infrared absorbing material may be configured or designed to reduce or eliminate infrared reflections (e.g., from the drum display surface) which may interfere with the reading of the barcode content (e.g., 602b, 603b, 612). Examples of different materials which may be used to form this layer may include, but are not limited to, one or more of the following (or combination thereof): infrared absorbers (such as those available from Adams Gates and Co., www.infraredabsorber.com); Aminium Dyes; Dithiolene Dyes; Phthalocyanine Dyes; Quinone Dyes; etc.

As illustrated in the example of FIG. 6, the alphanumeric content (e.g., 602a, 603a) is placed over or in front of the barcode content (e.g., 602b, 603b). However, in alternate embodiments (not shown), the barcode content (e.g., 602b, 603b) may be placed over or in front of the alphanumeric content (e.g., 602a, 603a).

Additionally, in at least some embodiments, the properties of the different materials used to form the barcode layer(s), alphanumeric layer(s), and/or other layer(s) of the meter display may be configured or designed to: (1) allow the alphanumeric content to be visible to a human observer when illuminated by a visible light source; and (2) allow the barcode content to be readable by an appropriately configured electronic reading device when the barcode content is illuminated by a non-visible light source (such as, for example, infrared light source, black light source, etc).

In at least one embodiment, the alphanumeric content may include one or more numbers, letters, characters and/or symbols, and may be displayed in a manner which makes it possible to read the meter data information (e.g., numeric value) by at least one method that may not include use of a electronic reading device such as a barcode reader.

In at least one embodiment, at least a portion of the features and/or materials described with respect to the example of FIG. 6 may be used for implementations of embodiments of meter displays described with respect to FIG. 5.

According to different embodiments, one or more gaming machines may include various types of meters such as, for example, hard meters, soft meters, digital meters, analog meters, and/or combinations thereof.

According to one embodiment, analog meters may use a needle and a calibrated scale to represent a value of recorded or measured data. In one embodiment, a user may interoperate values between major tick marks on an analog meter dial. According to specific embodiments, analog meters may be configured or designed to represent approximant values between units (e.g., 5.5, which represents a value between unit values 5 and 6).

In at least one embodiment, some digital meters may be configured or designed to display a value for the least significant digit of measured or recorded data. In one embodiment, a digital meter may further be configured or designed to eliminate the ability to interoperate between values. For example, in one embodiment, digital counting meters may be provided with indexed digits that represent units, tens, hundreds, and so, which, for example, may be used for counting items such as coins, people, etc.

As an example, an odometer on a car may be implemented in a manner which uses an analog-type meter mechanism for the least significant digit (e.g., representing one tenth of a mile values), and which uses a digital-type meter mechanism for representing the other digits of the odometer display (e.g., which, for example, may represent units, tens, hundreds, etc. of miles). In one embodiment, the “ 1/10^{th} mile” digit may be configured or designed to function in such a way that it is able to display a continuous range of values between 0.0 and 0.9 miles, while the other digits of the odometer may be configured or designed to function in such a way that each indexes from one value to the next value without representing values.

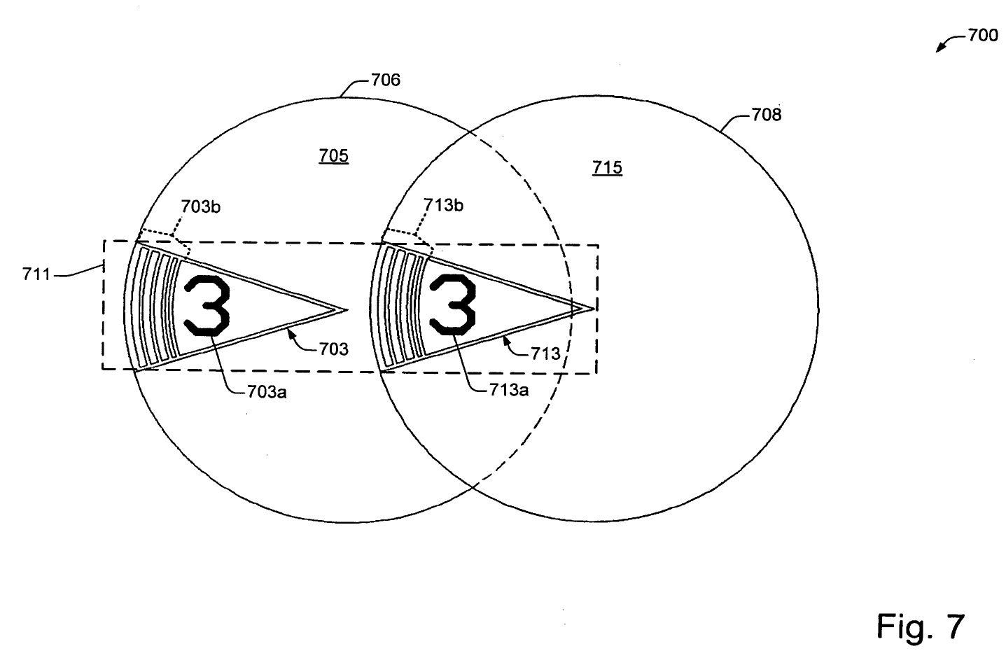

FIG. 7 shows an alternate example embodiment of a meter display portion 700. In the example of FIG. 7, meter display portion 700 is shown as including 2 circular discs 706, 708, in which each disc is shown displaying a respective portion of display content 707, 713. In other embodiments, the meter displays may include a fewer number or greater number of discs than that shown in the example of FIG. 7. In one embodiment, meter display portion 700 may be utilized as a portion of a hard meter display.

In at least one embodiment, each disc display surface (e.g., 705, 715) may include different portions of content (e.g., 703a, 703b, 713a, 713b) which, for example, may be printed the display surfaces, and/or printed on a label affixed to the display surfaces.

As shown in the example of FIG. 7, content sections 703, 713 include an alphanumeric portions 703a, 713a (which, in this example, each correspond to the numeral “3”), and barcode portions 703b, 713b, which are displayed using a plurality of graphical symbols. In at least one embodiment, barcode portions 703b, 713b may be formatted for display in accordance with a variety of a different machine readable display formats such as, for example, barcode array formats, matrix array formats, etc. Additionally, although the barcode portions are illustrated using vertical lines, in at least some other embodiments the barcode data may be represented using horizontal lines.

In at least one embodiment, the displayed barcode portions may be used to represent various types of information that have been encoded into barcode data suitable for display according to a selected barcode display format. For example, in one embodiment, the information represented by barcode portion 703b may be identical to the information represented by alphanumeric portions 703a. Thus, for example, in one embodiment, a barcode scanning device capable of reading barcode portion 703b may decode the barcode data represented by barcode portion 703b as corresponding to the number “3”.

It will be appreciated, however, that in other embodiments, the displayed barcode portions may be used to represent information other than or in addition to the information represented by their associated alphanumeric portions.

Although not illustrated in the example of FIG. 7, display surfaces 705, 715 may include other portions of content distributed about the display surfaces. For example, in one embodiment, each of the display surfaces 705, 715 may be divided into ten equal wedge-shaped sections (e.g., similar to sections 703, 713), with each section consuming about 1/10 (e.g., about 36 degrees) of the display surfaces. In at least one embodiment, each section of a display surface may be used to display content relating a different consecutive number within the range 0-9. Thus, for example, a first section of the display surface 705 may display alphanumeric data and/or barcode data representing the numeral “1”, a second section of the display surface 705 may display alphanumeric data and/or barcode data representing the numeral “2”, and so on. In one embodiment the section of the display surface 705 between the values 9 and 1 may display alphanumeric data and/or barcode data representing the numeral “0”.

According to specific embodiments, the barcode content of display surfaces 705, 715 may be read and recorded by a barcode scanner and/or other suitable electronic device. In one embodiment, only one section of content from each disc may be viewable/readable at any one time. For example, as illustrated in the example of FIG. 7, a window (e.g., represented by 711) or other mechanism may be provided for enabling a single section of content from each disc (e.g., 703, 713) to be viewable/readable at any given time. In other embodiments, the numbers of windows used, and their shapes may differ from that illustrated in FIG. 7. For example, in one alternate embodiment, a plurality of wedge-shaped windows (e.g., 2 wedge-shaped windows each having a size and shape similar to that of sections 703, 713, respectively) may be used to enable display of single section of content from each disc at any given time.

In alternate embodiments, the display surfaces of a disc (e.g., 706) may be divided into n sections, where n represents any integer greater than zero. For example, in one embodiment, display surface 705 may be divided into 12 equal sections, with each section representing a corresponding number from 0-11. In another embodiment, display surface 705 may be divided into 60 equal sections, with each section representing a corresponding number from 0-59. In a different embodiment, display surface 705 may be divided into 26 equal sections, with each section representing a corresponding letter from A-Z. Additionally, in some embodiments at least some sections may be of different dimensions, sizes, and/or shapes.

Additionally, in at least some embodiments, some of the display surfaces may include only barcode content and/or other types of machine readable content which may be read by an appropriately configured electronic device.

In at least one embodiment, one or more discs (e.g., 706, 708) may be mechanically linked together. For example, in one embodiment, disc 708 may be indexed (e.g., rotated) by the use of a solenoid (and/or other motion control device) to thereby change the section of content of that disc which is viewable through window 711. In one embodiment, if disc 708 is indexed ten times, disc 706 may be indexed one tenth of a revolution, thereby changing the section of content of that disc which is viewable through window 711 (e.g., from “3” to “4”).

In at least one embodiment, at least a portion of the features and/or materials described with respect to the examples of FIGS. 5 and/or 6 may be used for implementations of embodiments of meter displays described with respect to FIG. 7.

According to specific embodiments, an electronic reading device (such as, for example, a barcode scanning device) may be configured or designed to read and decode barcode content displayed at one or more locations at a gaming machine. Additionally, the electronic reading device may be operable to associate each barcode symbol (or specific groups of barcode symbols) with an alpha numeric character set. This character set may be stored in array which, for example, may be indexed by the gaming machine serial number. The electronic reading device may be further operable to transmit (e.g., via RF, IR, and/or hardwired communications) the indexed array of information, for example, to one or more remote system(s) of the casino network for storage in one or more databases.

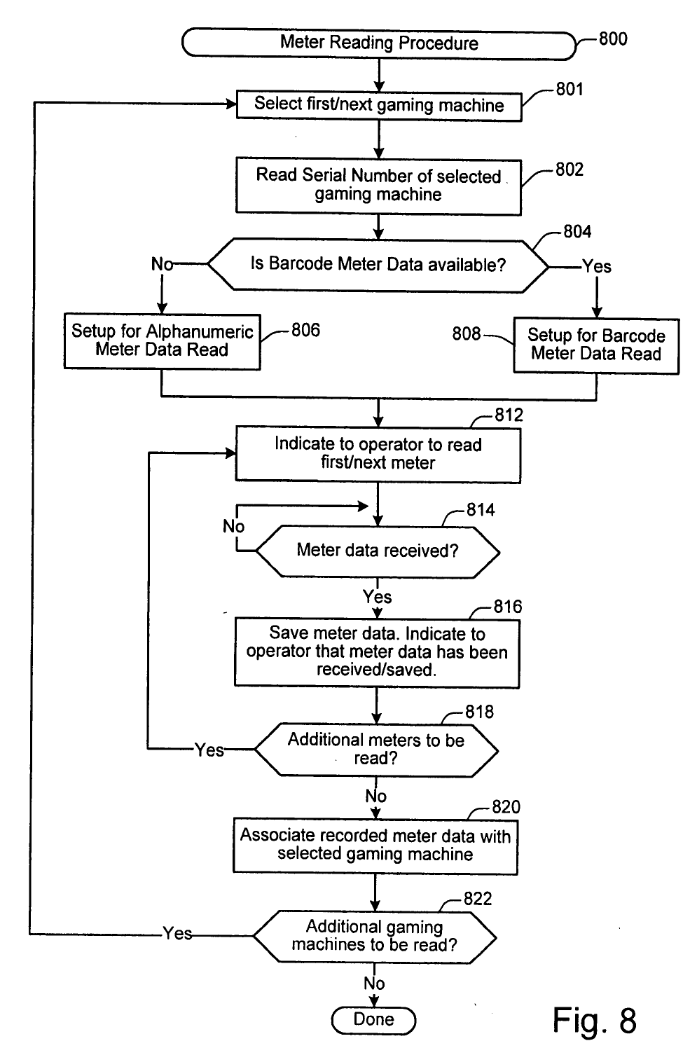

FIG. 8 shows a flow diagram of a Meter Reading Procedure 800 accordance with the specific embodiment of the present invention. In at least one embodiment, at least a portion of the Meter Reading Procedure 800 may be implemented by an electronic reading device such as, for example, a barcode scanning device and/or other mobile devices described herein. Additionally, in at least one embodiment, portions of the Meter Reading Procedure 800 may be implemented by a human such as, for example, a casino employee.

According to specific embodiments, Meter Reading Procedure 800 may be initiated during at least a portion of times when it is desirable to read the meter data (and/or other data) from one or more gaming machines located, for example, on the casino floor.

For example, in one embodiment, a casino employee may be instructed to read meter data associated with specifically identified gaming machines. In one embodiment, such instructions may be displayed to the casino employee via a display on an electronic reading device which, for example, has been assigned to the casino employee for use in scanning barcoded gaming machine data.

In the example of FIG. 8, it is assumed (e.g., at 801) that a specific gaming machine has been selected for meter reading activity.

At 802, the serial number of the selected gaming machine may be read and recorded. In one embodiment, the serial number may be read via the use of the electronic reading device. In other embodiments, the casino operator may manually read and record the gaming machine serial number.

At 804, a determination may be made as to whether barcode meter data is available at the selected gaming machine. For example, in one embodiment the casino employee may visually observe whether any barcode data is displayed at the gaming machine. In another embodiment, a profile of the attributes of the selected gaming machine may be stored at an electronic database (e.g., located at the electronic reading device and/or at a remote system of the gaming network). The profile information relating to the selected gaming machine may include information relating to whether or not any barcode data is available at the gaming machine. In one embodiment, the electronic reading device may access the gaming machine profile information in order to automatically determine whether or not any barcode meter data is available at the selected gaming machine.

In one embodiment, if it is determined that barcode meter data is available at the selected gaming machine, the electronic reading device may be set up or configured (808) for barcode meter data reading operation(s). In one embodiment, the electronic reading device may automatically and dynamically configured itself for implementing barcode meter data reading operations.

If it is determined that barcode meter data is not available at the selected gaming machine, the electronic reading device may be set up or configured (806) for alphanumeric meter data reading operation(s). In one embodiment, the electronic reading device may automatically and dynamically configured itself for implementing alphanumeric meter data reading operations. In other embodiments, the reading of the alphanumeric meter data may be performed by the casino employee (and/or other human), and manually input into the electronic reading device.

At 812, the casino employee (e.g., “operator”) may receive notification (e.g., from the electronic reading device) to commence reading the first meter display.

In at least one embodiment, the meter data (which, according to different embodiments may include alphanumeric data and/or barcode data) may be automatically scanned and read by the electronic reading device. In other embodiments, the meter data may be read by the casino employee, and manually entered into the electronic reading device.

Upon receiving (814) the meter data, the meter data may be stored (816) (e.g., in memory at the electronic reading device), and the electronic reading device may generate one or more signals (e.g., a beep, flashing light, etc.) to indicate that the meter data has been successfully received and saved.

In at least one embodiment, if it is determined (818) there are additional meters to be read at the gaming machine, the information from the additional meters may be read and stored at the electronic reading device. In one embodiment, at least a portion of the operations for reading and storing the additional meter information may be similar to operations 812-816 described previously.

Additionally, in at least some embodiments where a gaming machine includes some meters which include barcode data and also includes other meters which do not include barcode data, the electronic reading device may be automatically or manually reconfigured to support the reading and/or recording of the appropriate type and/or format of meter data which is displayed at the gaming machine.

In at least one embodiment, after desired meter data has been successfully read and recorded, the recorded meter data (or selected portions thereof) may be associated (820) with the selected gaming machine (e.g., from with the meter data was collected). In one embodiment, the recorded meter data may be associated with the selected gaming machine via the use of the gaming machine's serial number and/or other identifiers which may be used to uniquely identify that particular gaming machine.

In at least one embodiment, if it is determined (822) that meter reading activities (and/or other gaming machine information acquisition activities) are to be performed on additional gaming machines, a next gaming machine may be selected (801) for meter data (and/or other gaming machine data) collection activity.

According to various embodiments, at least a portion of the information which is stored in the memory of the electronic reading device may be provided to one or more remote systems and/or databases. In at least some embodiments, information from the electronic reading device may be provided to the remote system(s)/database(s) via one or more wireless communication links using one or more types of wireless communication protocols. In one embodiment, information from the electronic reading device may be provided to the remote system(s)/database(s) (e.g., via wireless communication) in real-time or near real-time (e.g., within a number of seconds from the time when the data is read by the electronic reading device). In some embodiments, the electronic reading device may be operable to perform wireless communication with a remote base station. In at least one embodiment, the remote base station may be configured or designed to forward data and/or other information received from the electronic reading device to one or more remote system(s)/database(s).

In other embodiments, information from the electronic reading device may be provided to the remote system(s)/database(s) via one or more wired communication links. For example, in one embodiment the electronic reading device may be inserted into a docking station which is configured or designed to access (e.g., download) the stored information from the memory of the electronic reading device. In one embodiment, the docking station may also be operable to store the information retrieved from the electronic reading device, and/or may also be operable to forward selected information retrieved from the electronic reading device to one or more remote system(s)/database(s).

It will be appreciated that, by establishing communications to the remote system(s)/database(s), the gaming machine serial number(s) and associated meter data may be automatically downloaded to remote system(s)/database(s), thereby eliminating much or all of the hand data entry operations typically required of previous gaming machine meter reading techniques. Moreover, once the appropriate gaming machine data has be provided a given system, that system may be capable of generating any desired analysis of the data (which, for example, may include graphs, enunciations, etc.).

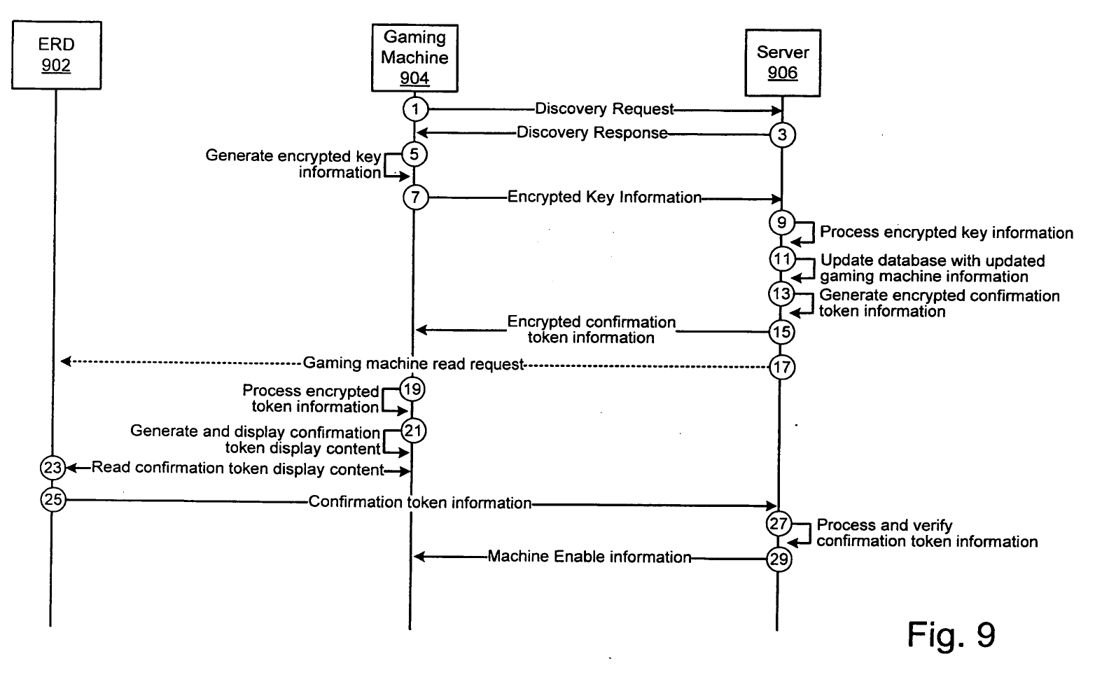

FIG. 9 shows an example of an interaction diagram in accordance with any specific embodiment. In at least one embodiment, at least a portion of the operations illustrated in the interaction diagram of FIG. 9 may be used to enable various functionality (such as, for example, game play functionality, wagering functionality, and/or other functionality) at a selected gaming machine (e.g., 904) of the gaming network.

According to different embodiments, at least a portion of the operations illustrated in the interaction diagram of FIG. 9 may be initiated in response to the occurrence of various conditions and/or events. For example, in at least some embodiments, it may be desirable to initiate at least a portion of the operations illustrated in the interaction diagram of FIG. 9 in various situations, for example, where it may be desirable to confirm or verify one or more communication channels between a selected gaming machine and a remote server system. Examples of such various situations may include, but are not limited to, one or more of the following (or combination thereof): (1) when deploying a new gaming machine on the casino floor; (2) when reinstalling or redeploying a serviced gaming machine back on the casino floor; (3) when initiating a new gaming machine for software download; (4) when initiating a gaming machine for software updates; (5) when querying a gaming machine for software validation, etc.

For purposes of illustration, it is assumed in the embodiment of FIG. 9 that gaming machine 904 has been recently been deployed at a location on the gaming floor, and that it is desirable to verify communication between gaming machine 904 and server 906 before enabling gaming machine 904 to conduct game play activities. In at least one embodiment, server 906 may correspond to a remote or backend server which is part of the casino gaming network.

As shown at (1), a discovery request message may be sent from gaming machine 904 to server 906. In at least one embodiment, the discovery request message may include information which describes various characteristics and/or attributes of the gaming machine such as, for example: serial number; model number; network information (ip address, MAC address, etc.); etc. According to different embodiments, communication between gaming machine 904 and server 906 may be implemented using a variety of different protocols such as, for example, UDP, TCP/IP, Ethernet, etc. Thus, for example, in one embodiment, the discovery request message may be formatted according to a UDP communication protocol.

At (3), it is assumed that server 906 receives the discovery request message and generates a discovery response message, which is transmitted gaming machine 904. In one embodiment, the discovery response may include information relating to the server. Additionally, in at least some embodiments, the discovery response may include encryption related information such as, for example, a public encryption key, a private encryption key, etc.

At (5) it is assumed that the gaming machine 904 receives the discovery response. In one embodiment, the gaming machine may use at least a portion of the information included in the discovery response to generate encryption related information (such as, for example, a symmetric encryption key). Additionally, in at least one embodiment, the encryption related information may be encrypted, for example, using the encryption information (e.g., public encryption key) provided by server 906.

At (7) it is assumed that gaming machine 904 provides encrypted key information to server 906. In one embodiment, the encrypted key information includes a symmetric encryption key (which, for example, was generated at the gaming machine) that has been encrypted using public encryption key provided by the server.

At (9) it is assumed that the server processes the encrypted key information received from gaming machine 904. In one embodiment, such processing may include, for example, decoding the encrypted key information in order to extract the symmetric encryption key information and/or other information relating to the gaming machine (such as, for example, the gaming machine serial number or other gaming machine identifier information).

As shown at (11), the server may update information relating to the gaming machine 904 in one or more databases. For example, in one embodiment, the server may update status information relating to gaming machine 904 to reflect that the activation or enablement of gaming machine 904 is “pending.” In another embodiment where a data structure is used to store information relating to “pending status” gaming machines, a new record may be created in or added to the data structure which is associated with gaming machine 904. In one embodiment, the record may include an identifier for gaming machine 904 and/or other information associated with the gaming machine.

At (13) it is assumed that the server 906 generates confirmation token information. In one embodiment the confirmation token information may include information intended for display at gaming machine 904, and which may be used for verifying proper operation of one or more communication channels between a gaming machine 904 and server 906. In at least one embodiment, the confirmation token information may also be encrypted. For example, in one embodiment, the confirmation token information may be encrypted using the symmetric encryption key provided by gaming machine 904.

At (15) it is assumed that encrypted confirmation token information is sent from server 906 to gaming machine 904. According to one embodiment, the server may then wait for a message and/or other signal which confirms display of the confirmation token information at gaming machine 904. Additionally, in at least one embodiment, the server may send (17) a gaming machine read request message to electronic reading device (ERD) 902, which, for example, may be used to notify a casino employee (and/or other operator of electronic reading device 902) that a request has been made read specific information (e.g., displayed confirmation token information) from gaming machine 904.

At (19) it is assumed that gaming machine 904 processes the encrypted confirmation token information. In at least one embodiment, the gaming machine may decode the encrypted confirmation token information in order to extract the confirmation token information. Additionally, in at least one embodiment, the gaming machine may use at least a portion of the confirmation token information to generate (21) confirmation token display content to be displayed at a display of the gaming machine 904. In one embodiment, the confirmation token display content may include machine-readable data (e.g., barcode data).

In at least one embodiment, when the confirmation token display content is ready for display that the gaming machine 904, the gaming machine may send a read request message to electronic reading device (ERD) 902, which, for example, may be used to notify a casino employee (and/or other operator of electronic reading device 902) that a request has been made read specific information (e.g., the displayed confirmation token content) at gaming machine 904.

At (23) it is assumed that the operator of electronic reading device 902 has been dispatched to the physical location of gaming machine 904, and that the electronic reading device 902 has been deployed to read the confirmation token display content. In at least one embodiment where the confirmation token display content is displayed as barcode data, the electronic reading device 902 may be operable to read and decode the barcode data to extract confirmation token information.

As shown at (25) the electronic reading device may provide the confirmation token information (and/or barcode data) to server 906. In one embodiment, at least a portion of the confirmation token information may be provided to server 906 via wireless communication, wired communication and/or some combination thereof. For example, in one embodiment, the electronic reading device may securely transmit confirmation token information to a base station via a wireless interface, and the base station may then forward the confirmation token information to server 906 via a wired interface. In other embodiments, electronic reading device 902 may be may be inserted into a docking station which is configured or designed to access (e.g., download) the confirmation token information from the electronic reading device. Once downloaded, the confirmation token information may be forwarded to server 906.

At (27) it is assumed that server 906 processes the received confirmation token information. In one embodiment, the server 906 may verify the accuracy of the received confirmation token information, for example, by comparing the received information with at least a portion of the confirmation token information that was generated at server 906 (e.g., at operation(s) 13).

In at least one embodiment, the server may make a determination as to whether or not to enable gaming machine 904 (e.g., for gaming related activities and/or other specific activities) based upon the verification of the confirmation token information that was displayed at gaming machine 904. Thus, for example, in one embodiment, the server 906 may enable game play and wagering functionality at the gaming machine 904 in response to verifying that the received confirmation token information conforms with expected criteria. However, if the server 906 determines that the received confirmation token information does not conform with expected criteria, server 906 may take appropriate action to prevent all or selected portions of functionality of the gaming machine 904 from being enabled.

In the example of FIG. 9 it is assumed that the server 906 has determined that the received confirmation token information conforms with expected criteria. Accordingly, at (29) the server may generate and send a machine enable message to gaming machine 904. In one embodiment, may include information relating to at least a portion of features at the gaming machine which are to be enabled. According to one embodiment, when gaming machine 904 receives the machine enable message, it may respond by automatically enabling and/or disabling specific features and/or functionalities.

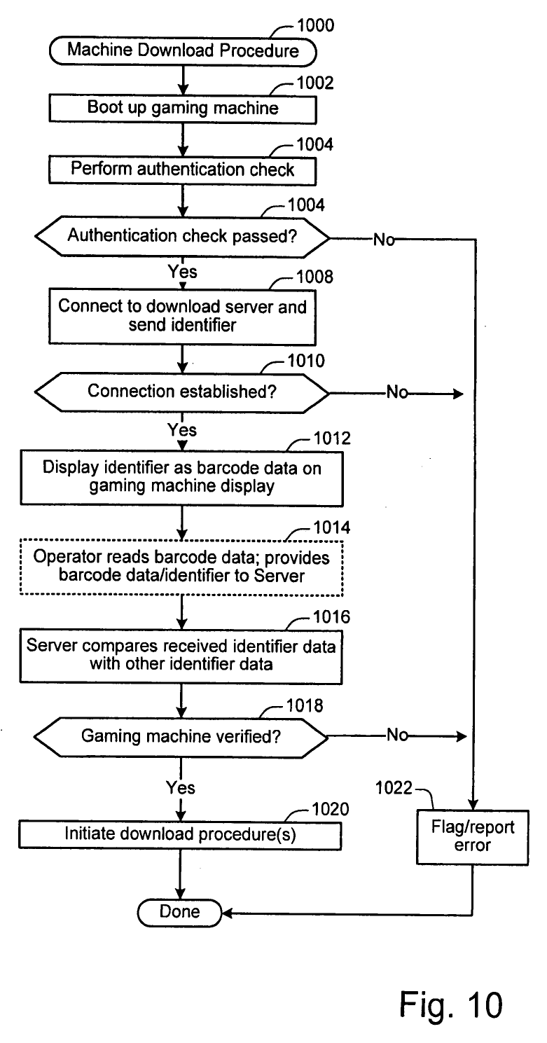

FIG. 10 shows a diagram of a Machine Download Procedure 1000 in accordance with the specific embodiment. In at least one embodiment, at least portions of the Machine Download Procedure of FIG. 10 may be implemented at a gaming machine (e.g., 904) in order to commence downloading of selected information (e.g., game code, display content, wager information, game play data, etc.) from one or more remote servers (such as, for example, server 906).

In the example of FIG. 10, it is assumed at 902 that the gaming machine boots up and performs an authentication check of it various hardware, software, and/or peripheral components.

In the example of FIG. 10, it is assumed that the authentication check passes (1004).

At 1008 the gaming machine may attempt to connect to a remote server (e.g., a download server). In one embodiment, the gaming machine may send identifier information to the download server, for example, in order to allow the download server to identify the gaming machine.

In the example of FIG. 10, it is assumed that a connection with the download server has been established (1010).

As shown at 1012, the gaming machine may display identifier information on a display of the gaming machine. In one embodiment, the displayed identifier information may be represented as (or converted to) barcode data and displayed using a barcode display format and/or other machine readable display format. In one the embodiment, the identifier information may have a predetermined algorithmic relationship with identifier information which was electronically transmitted from the gaming machine to the download server (e.g., at operation(s) 1008-1010).

At 1014 it is assumed that a casino employee has been dispatched to the physical location of gaming machine, and uses a electronic reading device to read the barcode data displayed at the gaming machine. In one embodiment, the barcode data (and/or other related information such as, for example, gaming machine identifier information) may be provided to the download server for analysis.

At 1016 it is assumed that the download server compares the received identifier data (e.g., which was read from the display of the gaming machine) with other identifier data such as, for example, identifier data which was electronically provided from the gaming machine to the download server. In one embodiment, the download server may use of the results of the gaming machine identifier comparison to verify (1018) or authenticate the identity of the gaming machine.

Thus, for example, if the download server determines that there is a match between the different identifier data, it may determine that the identity of the gaming machine has been verified (1018), and, in response, may allow download procedure(s) to be initiated (1020) between the gaming machine and the download server.

It will be appreciated that the Machine Download Procedure of FIG. 10 may be used to help improve network security. For example, an unauthorized device attempting to spoof the identity of a gaming machine (e.g., in order to download information from the download server to the unauthorized device) may be detected and/or flagged (e.g., 1022), for example, when the load server fails to verify that the spoofed identity of the unauthorized device matches identity information displayed at the gaming device (whose identity the unauthorized device is attempting to spoof).

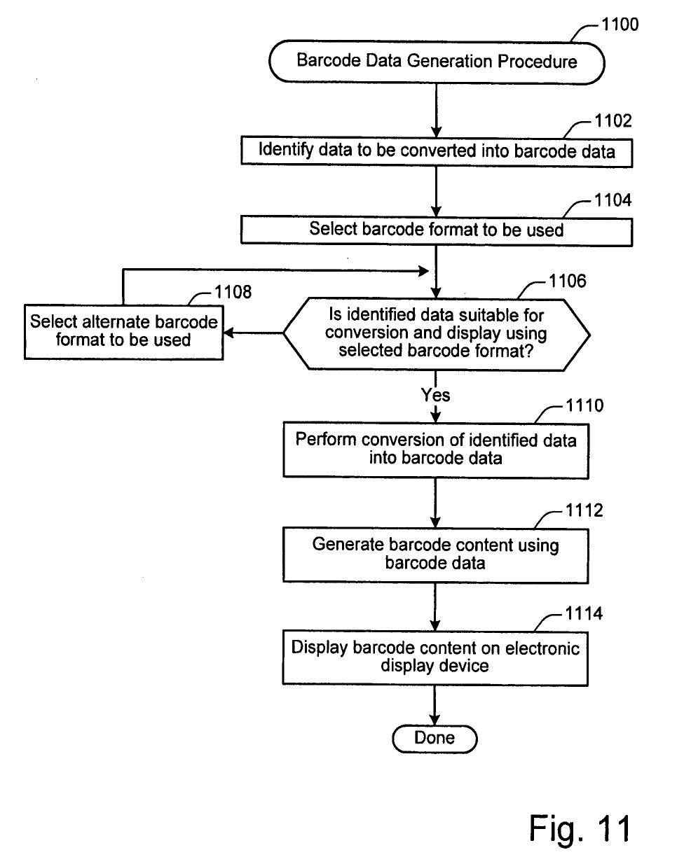

FIG. 11 shows a flow diagram of a Barcode Data Generation Procedure 1100 in accordance with a specific embodiment. In at least one embodiment, at least a portion of the Barcode Data Generation Procedure may be implemented at gaming machine in order to generate barcode content (and/or other types of machine readable content) which may be displayed at the display of the gaming machine.

In the example of FIG. 11, it is assumed that the Barcode Data Generation Procedure is implemented at a gaming machine such as, for example, gaming machine 904.

At 1102, selected portions of data may be identified which are to be converted into barcode data. In one embodiment, the selected portions of data may include one or more different types of gaming machine related information such as, for example: coin information; meter data; gaming machine serial number; confirmation token information; gaming machine identifier information; checksum values; network information; game download information; etc.

At 1104, a specific barcode format may be selected for use in converting the identified data into barcode data. According to specific embodiments, different types of barcode formats may be preferable for use with specific types of data. Moreover, in at least some embodiments, other types of machine readable display formats may be used to display machine readable display content at the gaming machine.

At 1106 a determination may be made as to whether or not the identified data is suitable for conversion and display using the selected barcode format. In one embodiment, if it is determined that the identified data is not suitable for conversion and display using the selected barcode format, then alternate barcode format (and/or alternate machine readable display format) may be selected (1108).

At 1110, the identified data may be converted into barcode data (and/or other types of machine readable data). In at least one embodiment, the barcode data will conform with the selected barcode format. In at least one embodiment, the conversion process may include, for example, encoding ASCII data into an appropriate barcode format.

According to specific embodiments, the barcode content may be generated (1112) using at least a portion of the barcode data, and displayed (1114) via an electronic display at the gaming machine. In at least one embodiment, the barcode content may be formatted for display on an electronic display of the gaming machine such that, when displayed, the barcode content may be readable by an appropriately configured electronic reading device.

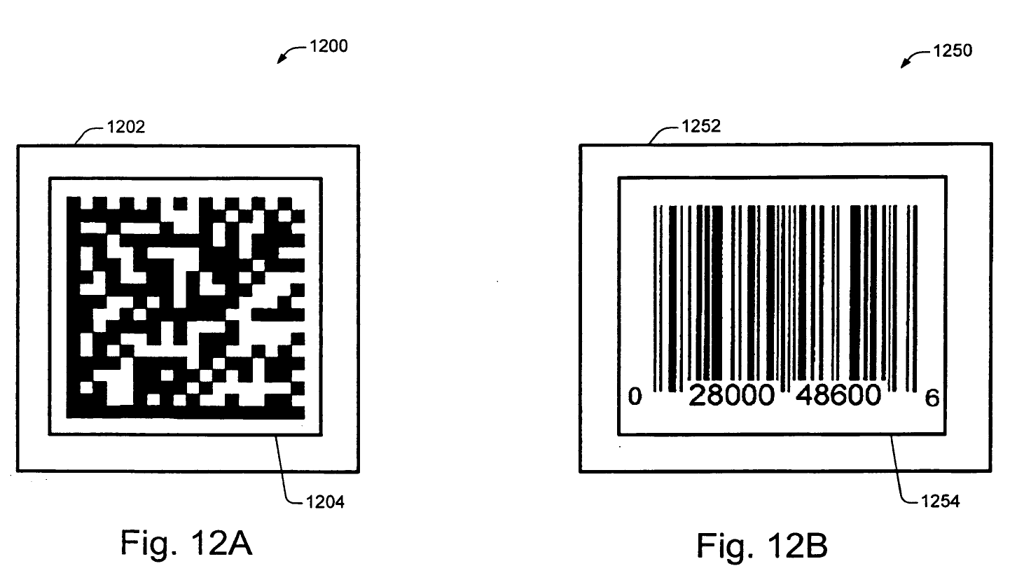

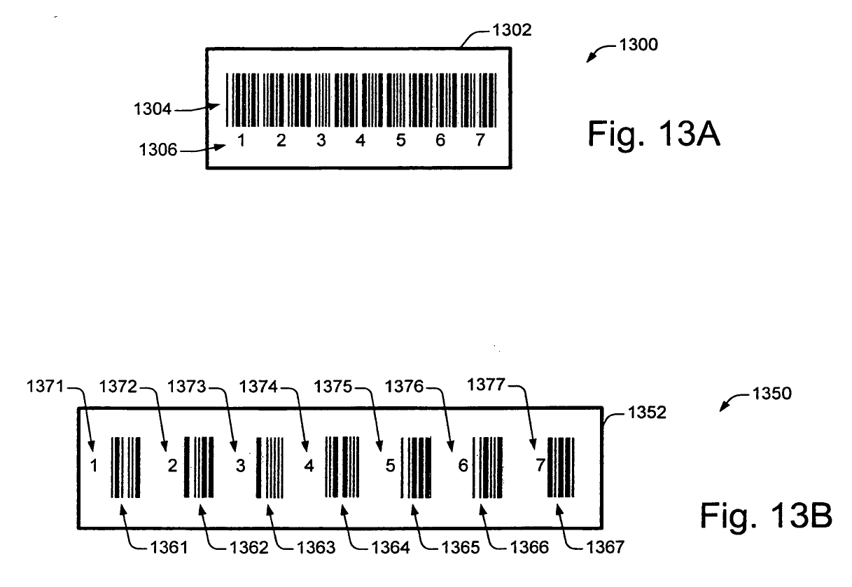

FIGS. 12-13 show various embodiments of types of machine readable display content which may be displayed at an electronic display device.

For example, as shown in the example embodiment of FIG. 12A, an electronic display 1202 may be used to display machine readable display content 1204 which includes matrix array symbology. According to specific embodiments, the matrix array may include different symbols having different sizes and/or shapes such as, for example: hexagonal, square, polygonal and/or other geometric shapes, lines, and/or dots.

As shown in the example embodiment of FIG. 12B, an electronic display 1252 may be used to display machine readable display content 1254 which includes barcode content. In at least one embodiment, the barcode content may include barcode symbols which conform with one or more types of barcode formats such as, for example, a UPC barcode format.

As shown in the example embodiment of FIG. 13A, an electronic display 1302 may be used to display machine readable display content which, for example, may include barcode data 1304 and/or alphanumeric data 1306. In one embodiment, the value of the barcode data represented at 1304 is equivalent to the value of the alphanumeric data represented at 1306.

As shown in the example embodiment of FIG. 13B, an electronic display 1352 may be used to display machine readable display content which, for example, may include barcode data portions (e.g., 1361-1367) and/or alphanumeric data portions (e.g., 1371-1377). In the example of FIG. 13B, the content displayed on electronic display 1352 is displayed using a format similar to at least one embodiment of a hard meter display format described, for example, with respect to FIG. 5. In other embodiments (not shown) content displayed on electronic display of a gaming machine may be displayed using one or more format(s) which are substantially similar to other types of hard meter display formats described herein.

In at least one embodiment, the values associated with one or more soft meters (and/or soft counters) of a given gaming machine may be graphically represented and displayed at an electronic display at the gaming machine using one or more different types of machine readable display content (such as, for example, one or more of the different types of machine readable display content described herein).

According to other embodiments, machine readable display content (e.g., in barcode format) may be displayed to a player via an electronic display at a gaming machine. In one embodiment, the player may capture the image of the barcode display using a camera (e.g., cell phone camera, PDA camera, etc) and/or other type of image capturing device.

Additionally, in at least one embodiment, different types of barcode data (and/or other machine readable data) displayed via an electronic display may be used for a variety of different purposes such as, for example: presentation of electronic coupons; presentation of promotions/rewards; presentation of bonuses; presentation of gaming information; automated download procedures; client-server identification; game attendant authorization (jackpot resets, tilt resets); etc.

Additional details relating to various aspects of barcode display technology are described in U.S. patent application Ser. No. 10/934,866, by Gelbman et al., filed Sep. 3, 2004, the entirety of which is incorporated herein by reference for all purposes.

Although several preferred embodiments of this invention have been described in detail herein with reference to the accompanying drawings, it is to be understood that at least one embodiment is not limited to these precise embodiments, and that various changes and modifications may be effected therein by one skilled in the art without departing from the scope of spirit of at least one embodiment as defined in the appended claims.

It is claimed:

1. A gaming machine comprising:
a master gaming controller;
a first meter operable to track gaming machine information, the first meter including a first meter display;
memory; and
at least one interface for communicating with at least one other device in a gaming network;
the gaming machine being operable to:
control play of a wager-based game; and
display a first portion of the gaming machine information at the first meter display;
wherein the first portion of gaming machine information includes a first portion of non-alphanumeric content formatted according to a first machine readable display format.

2. The gaming machine of claim 1:
wherein the first meter is implemented as a soft meter;
wherein the first meter display is implemented using an electronic display device;
wherein the first portion of gaming machine information includes meter data;
wherein the gaming machine is operable to convert the meter data into said first portion of non-alphanumeric content; and
wherein the gaming machine is operable to display the first portion of non-alphanumeric content at the electronic display device.

3. The gaming machine of claim 1:
wherein the first meter is implemented as a hard meter; and
wherein the first meter display is implemented as a mechanical display device.

4. The gaming machine of claim 1:
wherein the first meter is implemented as a hard meter; and
wherein the first meter display is implemented using a non-electronic display device.

5. The gaming machine of claim 1:
wherein the first meter is implemented as a hard meter;
wherein the first meter display is implemented as a mechanical display device; and
wherein the hard meter is operable to display the first portion of non-alphanumeric content at the mechanical display device.

6. The gaming machine of claim 1:
wherein the first meter display is implemented as a mechanical display device;
wherein the first portion of gaming machine information includes a first portion of alphanumeric content; and
wherein the first meter display is operable to display the first portion of alphanumeric content and the first portion of non-alphanumeric content at the mechanical display device.

7. The gaming machine of claim 1:
wherein the first portion of non-alphanumeric content includes barcode content which has been formatted in accordance with a first barcode display format; and
wherein the first meter display is operable to display the barcode content via a mechanical display device.

8. The gaming machine of claim 1:
wherein the first portion of non-alphanumeric content includes barcode content which has been formatted in accordance with a first barcode display format; and
wherein the first meter display is operable to display the barcode content via an electronic display device.

9. The gaming machine of claim 1:
wherein the first meter display is implemented as a mechanical display device;
wherein the first portion of gaming machine information includes a first portion of alphanumeric content;
wherein the first meter display is operable to display the first portion of alphanumeric content and the first portion of non-alphanumeric content at the mechanical display device; and
wherein the first portion of non-alphanumeric content is displayed in such a manner that it is not visible to a human observer during a first time when the first portion of non-alphanumeric content is illuminated using a visible light source.

10. The gaming machine of claim 1:
wherein the first meter display is implemented as a mechanical display device;
wherein the first portion of gaming machine information includes a first portion of alphanumeric content;
wherein the first meter display is operable to display the first portion of alphanumeric content and the first portion of non-alphanumeric content at the mechanical display device; and
wherein the first portion of non-alphanumeric content is displayed in such a manner that it is detectable only during times when the first portion of non-alphanumeric content is illuminated using a non-visible light source.

11. A meter device operable for use with an electronic gaming machine, the gaming machine being operable to control play of a wager-based game, the meter device comprising:
an information tracking mechanism operable to track gaming machine information relating to the gaming machine;
at least one interface;
a first meter display operable to display meter data relating to the tracked gaming machine information;
the meter device being operable to display a first portion of the meter data at the first meter display;
wherein the first portion of meter data includes a first portion of non-alphanumeric content formatted according to a first machine readable display format.

12. The meter device of claim 11:
wherein the first meter is implemented as a soft meter;
wherein the first meter display is implemented using an electronic display device;
wherein the first portion of meter data includes meter data;
wherein the gaming machine is operable to convert the meter data into said first portion of non-alphanumeric content; and
wherein the gaming machine is operable to display the first portion of non-alphanumeric content at the electronic display device.

13. The meter device of claim 11:
wherein the first meter is implemented as a hard meter; and
wherein the first meter display is implemented using a mechanical display device.

14. The meter device of claim 11:
wherein the first meter is implemented as a hard meter;
wherein the first meter display is implemented using a mechanical display device; and
wherein the hard meter is operable to display the first portion of non-alphanumeric content at the mechanical display device.

15. The meter device of claim 11:
wherein the first meter is implemented as a hard meter;
wherein the first meter display is implemented as a mechanical display device;
wherein the first portion of meter data includes a first portion of alphanumeric content;
wherein the meter device is operable to display the first portion of alphanumeric content and the first portion of non-alphanumeric content at the mechanical display device.

16. The meter device of claim 11:
wherein the first portion of non-alphanumeric content includes barcode content which has been formatted in accordance with a first barcode display format; and
wherein the first meter display is operable to display the barcode content via a mechanical display device.

17. The meter device of claim 11:
wherein the first portion of non-alphanumeric content includes barcode content which has been formatted in accordance with a first barcode display format; and
wherein the first meter display is operable to display the barcode content via an electronic display device.

18. The meter device of claim 11:
wherein the first meter display is implemented as a mechanical display device;
wherein the first portion of meter data includes a first portion of alphanumeric content;
wherein the first meter display is operable to display the first portion of alphanumeric content and the first portion of non-alphanumeric content at the mechanical display device; and
wherein the first portion of non-alphanumeric content is displayed in such a manner that it is not visible to a human observer during a first time when the first portion of non-alphanumeric content is illuminated using a visible light source.

19. The meter device of claim 11:
wherein the first meter display is implemented as a mechanical display device;
wherein the first portion of meter data includes a first portion of alphanumeric content;
wherein the first meter display is operable to display the first portion of alphanumeric content and the first portion of non-alphanumeric content at the mechanical display device; and
wherein the first portion of non-alphanumeric content is displayed in such a manner that it is detectable only during times when the first portion of non-alphanumeric content is illuminated using a non-visible light source.

20. A gaming machine comprising:
a master gaming controller;
a first electronic display;
memory; and
at least one interface for communicating with at least one other device in a gaming network; and
the gaming machine being operable to:
control play of a wager-based game;
identify a first portion of data to be presented for display at the first display using a machine readable format;
convert the first portion of data into non-alphanumeric content formatted according to a first machine readable display format; and
display the non-alphanumeric content at the first display.

21. A gaming system comprising:
a first gaming machine including a first display;
a first server system; and
a first electronic reading device;
the first gaming machine being operable to:
control play of a wager-based game;
identify a first portion of data to be presented for display at the first display using a machine readable format;
present the first portion of data for display at the first display using non-alphanumeric content formatted according to a first machine readable display format;
the first electronic reading device being operable to:
read the non-alphanumeric content displayed at the first display;
determine the first portion of data using at least a portion of the read non-alphanumeric content;
forward at least a portion of the first portion of content to the first server system.
